(19) United States
(12) Patent Application Publication
(10) Pub. No.: US 2004/0203909 A1
(43) Pub. Date: Oct. 14, 2004

(54) Systems and methods for location dependent information download to a mobile telephone

(76) Inventor: Karl H. Koster, Atlanta, GA (US)

Correspondence Address: Karl H. Koster, 5880 Pine Brook Road, N.E., Atlanta, GA, 30328, US

(21) Appl. No.: 10/334,538

(22) Filed: Jan. 1, 2003

(51) Int. Cl. H04B 1/10

(52) U.S. Cl. 455/456.1; 455/457; 455/213

(57) ABSTRACT

A wireless system provides location dependent information to a user upon request by the user. The user request typically includes location information, user identification information, and a service indication. The network identifies the type of information to be provided, obtains the information as necessary from an information service provider, and downloads the information. The information downloaded depends at least on the geographical location of the user as well as information contained in the user's service profile. Downloaded information may include text, graphical, audio, or a combination of types. Further interactions with the user are defined by the information service invoked. A typical application would allow a mobile telephone user standing near a movie theater to receive information regarding a movie showing and purchase tickets to a particular movie.

### BACKGROUND OF THE INVENTION

The last decade has witnessed an extraordinary growth in the use of wireless telephones. Early cellular telephones were bulky, barely portable, and of marginal voice quality. Modern digital cellular phones (including personal communication services based mobile phones) have matured into very small and convenient devices with long battery life and near wireline voice quality. Many digital phones are now the size of a deck of playing cards, have battery standby times of several days, and are quite affordable. Their use has become quite ubiquitous among all population segments.

As manufacturers have successfully reduced the size of the phone, many are now focusing on increasing the features and capabilities. One such direction has been to incorporate text based messaging to units. One such capability, known as Short Messaging Service, allows short text strings to be sent to a wireless phone. Another effort by mobile phone manufacturers and wireless service providers has been to provide wireless access to the Internet. Another effort is to incorporate a display capable of displaying images. Some phones even incorporate a digital camera and the ability to transmit and receive digital images. Certainly, the ability to receive information in more formats provides the potential for more service capabilities.

Cellular phones have also proven beneficial as a means for emergency communication. Many individuals carry cellular phones while traveling in automobiles as a safeguard for dealing with emergency situations. Indeed, a great deal of emergency calls now originate from mobile phones and are beneficial for quickly reporting accidents on highways. While the enhanced 911 system (E-911) provides information relating to a caller's origin for wireline calls, such as the caller's originating address, additional modifications are required to provide a similar capability for wireless calls. With mobile calls, there is no fixed location associated with the service, so that E-911 call centers cannot easily determine the location of the caller. To rectify this problem, the FCC has required wireless service providers to install equipment to determine the location of the caller when originating an E-911 call. To accommodate this, various wireless providers are using signal timing technology based on the principles of triangulation to determine the location of the caller. While this method has the benefit of working with various existing mobile phones, it has the disadvantage of having limited accuracy. Further, while this technology allows the service provider to determine the caller's location for E-911 calls, this does not readily allow provision of other location-based services for non-emergency calls.

A different wireless technology that has proven useful to determine location is known as GPS—Global Positioning System. This involves a number of geosynchronous satellites (typically, at least 24) sending a plurality of precisely coordinated signals for that are received by a GPS receiver allowing precise determination of geographic location. Further, techniques, such as differential GPS, allow very precise location determination. Unlike the wireless technology adapted for location determination of wireless E-911 calls, this technology was initially designed for location determination and has proven useful for a myriad of applications from tracking assets to determining the location of hikers in a national park.

Despite the above advanced technological capabilities related to providing mobile services, there are a number of basic abilities that are not provided to mobile users of communication devices. The main advantage of such wireless technologies is that they allow mobility, but many users find they are limited in obtaining information precisely during such situations when they are mobile. For example, mobile users frequently do not have ready access to telephone books, but may desire certain information such as the number of a nearby business. While many mobile telephones allow programming of commonly used telephone numbers, this does not solve the problem obtaining numbers that are not stored in the mobile phone. Nor does access to a directory service readily solves the problem since often times the directory assistance operator is usually not familiar with the vicinity of the caller and the caller may not always know their precise geographical location. For example, a mobile phone user may be in the vicinity of a bank, but may not know the particular name of the branch of the bank or street address. It would be desirable if the user could readily and conveniently obtain information regarding a nearby bank without knowing the particular address of the bank.

It would also be advantageous for a mobile phone user to receive information in non-audio form. For example, currently, a mobile phone user can call a movie theater to receive audible information regarding which movies are playing, but this requires knowledge of the number and further presents the information in audible form. The degradation of customer service results in callers first receiving an announcement and talking to a human operator can incur a very long waiting time. A user may desire to receive the information in textual form, particularly if they are in a noisy environment. While wireless internet is available to mobile phone users, such applications are often impractical for fast and convenient use. Usually a caller would require call directory assistance to receive the number, and even if automatically dialed by the service, an additional charge is incurred.

The prior art in form of U.S. Pat. No. 6,400,956, entitled Method and Apparatus for Wireless Telecommunication System That Provides Location-Based Action Services, describes a system that actuates applicances by sending a control signal to turn on or off a light, garage door, coffee pot, et cetera. Further, this system operates by monitoring the location of the user and initiates the actions on the user's behalf. The prior art systems do not disclose a system of the user requesting information and where the information provided is based, in part, on their geographical location.

Therefore, there is a need to provide information to a mobile user in an easy to use manner based on the location of the user. The combination of a digital display on a mobile phone capable of presenting color images, an accurate mobile location determination system, and enhanced data communication abilities to a mobile communications device facilitate the provision of location dependent information services to the mobile user.

### SUMMARY OF THE INVENTION

The present invention is directed to a wireless telecommunications system that allows users to request information to be downloaded to them based in part on the geographical location of the user. The network interprets the request to determine the type of service to be provided and downloads information to the user. The information can be graphical, textual, or audible, and can further comprise further interactions with the user as defined by the service. The subsequent user interactions can be used to, for example, purchase items, make dinner reservations, obtain information regarding a business or business location, obtain information regarding a dispatch location, et cetera.

### BRIEF DESCRIPTION OF THE DRAWINGS

FIG. 1 illustrates components of a mobile device embodying the principles of the present invention.

FIGS. 2A and 2B illustrates the components of a wireless system embodying the principles of the present invention.

FIG. 3 illustrates the components of an Information Service Provider embodying the principles of the present invention.

FIGS. 4A and 4B illustrate the concepts of absolute and relative location determination embodying the principles of the present invention.

FIGS. 5A and 5B illustrate the concepts of user-specific and generic location dependent information download signaling embodying the principles of the present invention.

FIG. 6 illustrates the processing for determining a user-specific or generic location request embodying the principles of the present invention.

FIG. 7A illustrates a prior art traffic status map.

FIG. 7B illustrates the processing associated with requesting a traffic status map embodying the principles of the present invention.

FIG. 7C illustrates the database structure of the adjunct processing system embodying the principles of the present invention.

FIG. 7D illustrates a downloaded information traffic status map embodying the principles of the present invention.

FIG. 8A and 8B illustrate maps for detailing the location points of interest to a user embodying the principles of the present invention.

FIG. 8C illustrates the processing of a download request associated with the dispatch application embodying the principles of the present invention.

FIG. 9A illustrates a map detailing a dispatch location embodying the principles of the present invention.

FIG. 9B illustrates the processing associated with the dispatch application embodying the principles of the present invention.

FIG. 10A illustrates an application of location dependent information download according to the principles of the present invention.

FIG. 10B illustrates the information presented to the user according to the principles of the present invention.

FIG. 11A illustrates a movie-theater ticket purchase application according to the principles of the present invention.

FIG. 11B illustrates the subscriber data associated with the movie-theater purchase application according to the principles of the present invention.

FIG. 12 illustrates a vending machine purchase application according to the principles of the present invention.

FIGS. 13A-C illustrate various service application involving a call center embodying the principles of the present invention.

### DETAILED DESCRIPTION

The present inventions now will be described more fully hereinafter with reference to the accompanying drawings, in which some, but no all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense and not for purposes of limitation.

The illustrative embodiments of the present invention enable a mobile device to initiate an information download to the mobile device by a wireless service provider based on the location of the mobile device. In the embodiments illustrated, a person (“user”) operates the mobile device, although an other embodiments, an computer software executed on the processor in the mobile device could, in many instances, perform the functions of the user. Illustrating the embodiments of the invention with a user is not intended to limit the invention to human initiated actions nor providing information in human readable form. Further, the term ‘user’ is sometime used synonymously with ‘mobile terminal’ depending on the context.

The mobile device is illustrated herein as a cellular or PCS mobile telephone, although other devices could be used, such as mobile data terminals, laptops, personal digital assistants (PDAs), combined PDA/mobile telephones, and other various combinations of the above including devices not explicitly identified. Illustrating the embodiments of the invention with a PCS mobile phone is not intended to limit the invention to such handheld voice oriented devices, but only illustrate exemplary applications. The principles of the invention apply to any mobile computing apparatus, including those applications involving computers integrated into vehicles, including computerized location mapping display systems. Similarly, a variety of wireless protocols could be adapted to implement the principles of the present invention.

The information download may be often illustrated herein as a single transfer of graphical information to a user. However, the information downloaded may comprise multiples downloads, as for example, when a user is interacting with the system. Further, the information downloaded could be of a graphical format, text format, or a combination of the two using a variety of protocols. Further, the information downloaded could be audio information in the form of, for example, pre-recorded voice messages. Thus, illustration of embodiments providing a single transfer of graphical information is not intended to limit the invention. The flexibility and wide range of applications of applying the principles of the present invention will become apparent as the various embodiments are presented.

The invention allows a user to request information based on their geographical location for a variety of applications. In these embodiments, the geographical location of the user is assumed to be proximate to the mobile device (e.g., the user is holding the mobile device), so that for practical applications the location of the mobile phone and user are treated as identical. The location of the mobile device is preferably obtained by using GPS technology implemented within the mobile device to obtain its location coordinates (“GPS coordinates”). The mobile device sends this location information to the network in addition to a request triggering the information download. The system receiving and processing the request tailors the information to be provided based to the user based, in part, on the location of the mobile device. Alternatively, other means for determining the location of the mobile device can be used. The system providing the information may refer to a collection of systems or subsystems, and is often referenced as ‘the wireless service provider’ for convenience.

Two types of information download are defined—generic and user-specific. These categories are intended to conceptually aid in the description of the embodiments of the invention and not to limit application or operation. In the generic download scenario, information provided to the mobile device is based on the mobile user's location, and does not consider the user's identify when making the request. In user-specific information downloads, information provided to the user is based on the user's location and does consider the user's identify that is making the request. The provision of other forms of information may be considered in either case for determining the service and information downloaded (time of day, authorization levels, function key signaled, etc), but the high level distinction of user-specific and generic request types are useful to illustrate the embodiments of the present invention.

The user triggers the information download process by sending a request to the service provider. “Service provider” can refer to the wireless service provider and/or an Information Service Provider, and the meaning depends on the specific implementation depending on what service is provided and how it is provided. Alternatively, an application process executing in the mobile device may trigger the request, based on various criteria including the location of the device. The user request can be made in a variety of ways using various technologies and protocols, and various embodiments are illustrated. Since the user-specific request also requires the identity of the user to be known to the network, this request preferably includes the user's mobile telephone number that functions as the means of identification. Based on the technology and signaling used, other types of information could be used to identify the user. For example, in some wireless systems, other numbers function for addressing messages to the user may be used to identify the user. For example, in GSM, mobile terminals are identified by the IMSI (International Mobile Station Identifier). Other systems, such as certain paging systems utilize proprietary numbering schemes. Similarly, there are addressing schemes for aircraft and maritime applications. Other technologies may use an established communication channel by which a user was previously identified and associate any signaling on that channel with the user. In the generic request, the user's identification is usually not required by the service provider to respond to the information download request, but it may nevertheless may be included by the user in signaling the request. A potential motivation for including the user identification information is consistency of signaling by the mobile terminal. In some instances even if the user's identification is provided, the system may not utilize it. In other applications, the system will utilize the user identification if provided.

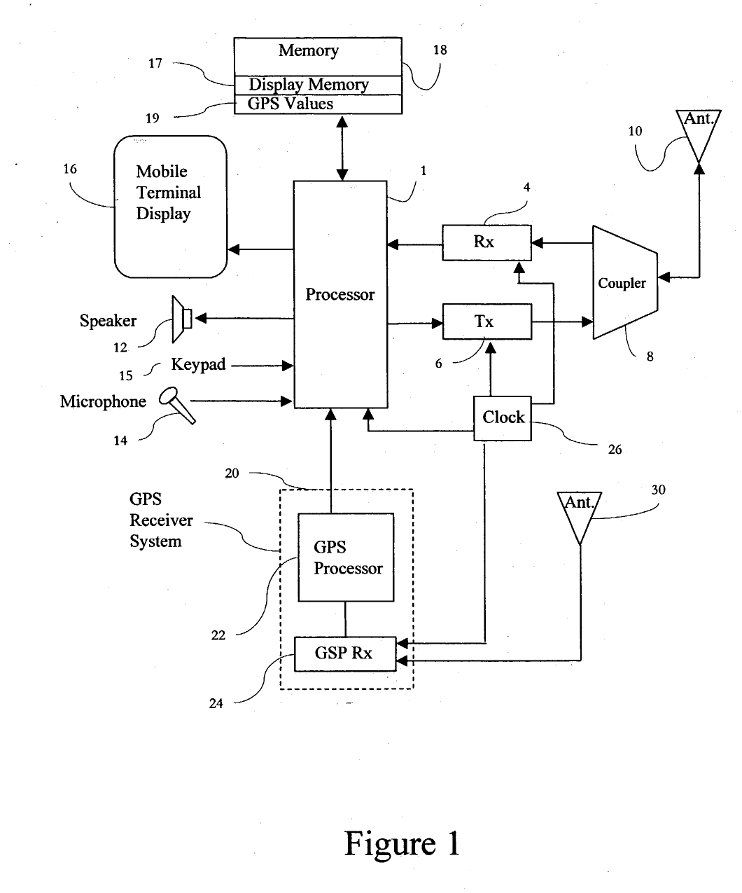

A mobile device operated by the user and illustrating the embodiment of the invention is shown using functional components of an advanced mobile telephone in FIG. 1. As previously noted, other types of mobile devices such as laptops and PDAs can be used to embody the principles of the present invention. In FIG. 1, the mobile phone contains a processor 1 that may be a special purpose microprocessor for controlling the mobile device. That is, the processor may be constructed for wireless communications applications. Alternatively, the processor may be a generic microcontroller or microprocessor adapted for such purposes. The processor receives communication data from a receiver 4 that is obtained from the mobile phone's antenna 10. The signal received by the antenna may pass though a coupler 8 prior to processing by the receiver 4. The receiver provides digital data representing the signal received in a digital form compatible to the processor. The processor 1 also provides digital data to the transmitter 6 that passes through the coupler 8 prior to being sent the antenna 10. The information sent and received may represent a variety of digital data, including, but not limited to: digital voice signals, data digital signals, and control digital signals.

The transmitter and receiver are tuned for a set of frequencies based on the frequency band the device is designed to operate on, and as illustrated here, a separate clock 26 provides the reference frequencies to the receiver and transmitter. In other embodiments, separate clocks or other timing circuitry may be used for generating timing signals since difference frequency of clock signals are usually required.

The processor 1 is operatively connected to a speaker 12 that provides audible output to the user. This may be implemented using an integrated speaker in the mobile phone or via an earpiece inserted in the user's ear. The speaker is capable of providing a range of frequencies, so as to allow the user to hear audible voice frequencies and feedback indications. The processor 1 also is operatively connected to a microphone 14 that is often implemented as an integrated device in the mobile phone. As with the speaker, separate non-integrated microphones can be used, which are often attached using a standard jack.

The processor 1 also receives keypad information 15. The keypad comprises a number of keys, including the keys typically associated with telephony dialing (e.g., 0-9, * and #) as well as specific functions keys that can be implemented as separate keys (for example, labeled as “F1”) or which can be implemented as a combination of keys (e.g., “*5”). In addition, the keypad input is intended to encompass any other type of input as required, including mouse input, softkeys (programmable function keys), stylus depression indications, touchpad input, et cetera. Many of the keypad inputs depend on the physical nature of the mobile device. For example, a processor installed in an automobile may incorporate pushbuttons on the dashboard or softkeys indicated on a display. However, on a mobile phone, traditional physical keys are used for input indication. The application of speech recognition would also be logically viewed as keypad input, even though it uses the microphone as an input device.

The processor 1 also is operatively connected to a display 16 that may be implemented as a LCD monochrome or color screen. Preferably, the display for the mobile device is a color LCD bit mapped display able to display numerous colors in high resolution. Alternatively, a number of other display technologies can be used. Typically, the displays on a mobile device may be of limited display size, although mobile devices with larger displays may be used according the principles of the current invention. As is well known in the art of mobile phone design, mechanisms for allowing the user to select information are well known. This may be accomplished by arrow keys for moving a cursor, a ‘thumbwheel’ for scrolling through items in a list, et cetera. The means for the user to select and item on the screen is based on commonly known mechanisms; however a variety of emerging technologies can be used for accomplishing such functions, including speech recognition and handwriting analysis.

The processor 1 also interacts with memory 18 that is illustrated as having a portion allocated to the display contents 17 and as well as containing the location coordinates, which are in referred to as the GPS coordinates 19. The memory may contain further structure for storing display or GPS coordinates. The memory further stores other information necessary for the operation of the mobile device, such as resident programs in non-volatile memory.

Finally, the processor 1 also interacts with a GPS Receiver System 20. This is shown as comprising a GPS processor 22 and a GPS Receiver 24. Other forms of implementations are possible, and are encompassed by the scope of the invention, such as using the processor 1 to perform the functions of the GPS processor 22. The GPS receiver 24 is shown as receiving a signal from a dedicated antenna 30, but other implementations can embody the principles of the invention by incorporating common components where possible.

The GPS receiver 24 is shown as receiving a clock signal from the clock 26, although a separate clock circuit may exist in the GPS receiver system 20. Although a common clock 26 is shown as providing timing to the processor 1, transmitter 6, receiver 4 and the GPS receiver 24, the timing signals and characteristics may be different. Thus, the clock 26 may comprise multiple clock circuits.

The interaction of the processor 1 and the GPS receiver system 20 are such that a variety of means of communicating the location information to the processor can be performed. For example, the GPS receiver can continuously determine the position, and report the location information to the processor upon request. Alternatively, the processor may periodically poll the GPS receiver system for location information (e.g., every 5 seconds). Alternatively, the processor may request location information only when required (e.g., when a user requests an information download). Any of the above methods or other methods for obtaining the location information when required can be used. Other variations of the architecture include the GPS Processor writing the information directly to the memory 18 or incorporating its own memory that can be accessed by the processor. Such variations are intended to be within the scope of the present invention. Further, the mobile phone may have other functions for allowing the user to interact with the display regarding to location determination. For example, the user may be able to request viewing the longitude and latitude coordinates of GPS, or select various options regarding GPS operations that do not involve information download.

The principles of the present invention encompass other location technologies. For example, alternative location determination technologies have been deployed by wireless service providers in response to federal mandates for emergency location determination of wireless phones (“wireless E-911). These are based on measuring signal timing from the mobile terminal to a plurality of base stations (“towers”). Although typically not as accurate as GPS, the invention encompasses such other location determination technologies. According to the principles of the invention, the location of the mobile device can be determined using this technology. The user can request to the service provider that information be downloaded based on that location as determined by the network. In the preferred embodiments illustrated, the mobile device determines the location and includes this information to the network by communicating its GPS coordinates. In other embodiments, the network may be able to determine the location of the mobile device based on signal timing or other location determination technologies. For example, in one embodiment, the network is able to determine the location of the user by the cell site that is being used. Normally, this is not a precise method of locating a user since this encompasses any location in a circle defined by the range of the network antenna transmitting information. For cellular applications, this can be measured in miles. However, in other embodiments, the antenna is a low power antenna providing a very limited area of access. Specifically, some of the recent low power Wi-Fi (wireless fidelity) services allow sufficiently precise location of the user once the receiving antenna is identified. Often, these services are provided as complimentary Internet access mechanisms to patrons in coffee shops or other business locations. Examples of service providers includes Cometa Networks, Boingo, and T-Mobile. In such embodiments, the user may indicate a request for information download and the network provides the user's coordinates based on the location of the antenna. Thus, a user in a coffee shop requesting an information download is provided advertising information (e.g., coupons, specials, etc.) appropriate for the location.

As illustrated in FIG. 1, one embodiment involves the user to press certain keys on the mobile phone which the processor interprets as an information download request, causing the GPS values to be sent to the service provider. As previously noted, the processor 1 may obtain the GPS values from the GPS Receiver System 20 or the processor may read the current values stored in memory 19. The operation of the processor with respect to controlling a voice call on the mobile device is independent from controlling the GPS functions. Thus, information downloads could be invoked while the user is on a call.

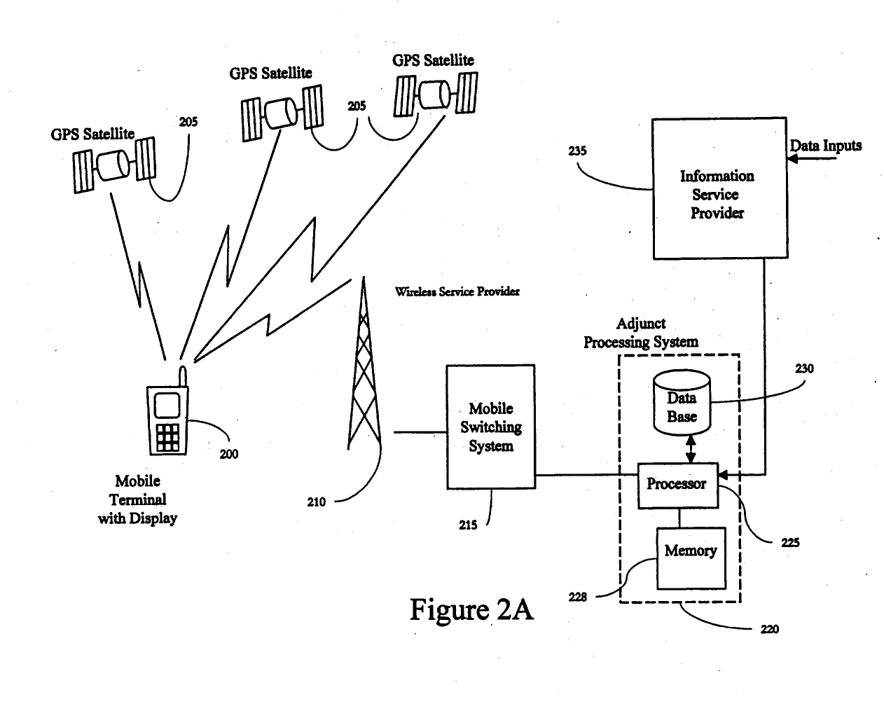

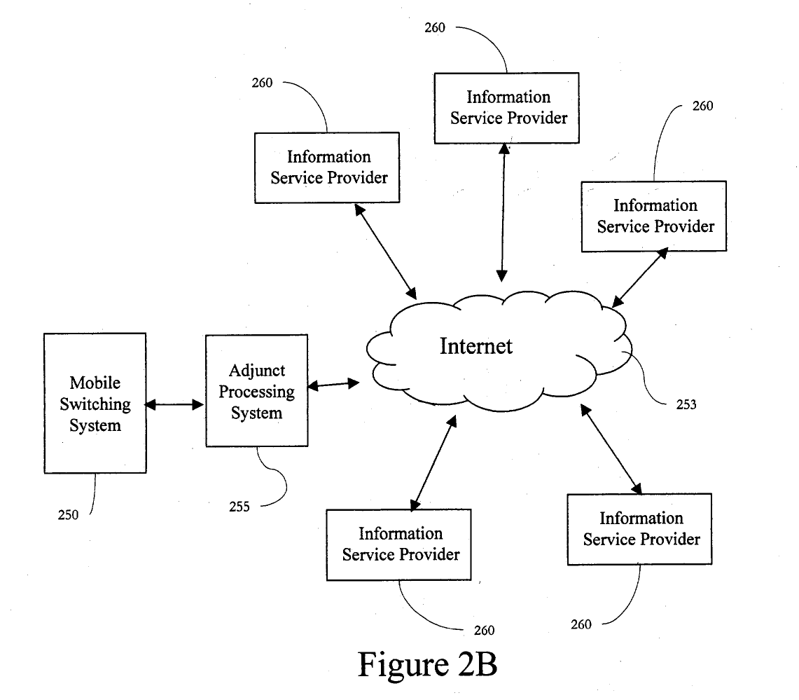

The system in which the mobile terminal is used is shown in FIG. 2. The ‘system’ can be interpreted as all the other components other than the mobile terminal necessary to provide the operation of the service. The exact components will vary based on implementation to implementation, and the illustration of FIG. 2 can be varied in numerous ways while still keeping in the spirit of the invention. The mobile terminal 200 includes a display for presenting information, voice capability, and a GPS receiver. The GPS receiver receives signals from a plurality of GPS satellites 205 (of which three are shown in FIG. 2). The GPS system comprises more than three satellites (typically at least twenty-four, with additional satellites functioning as backup) and their orbital positions are precisely defined. The details of the operation of the GPS system are not provided herein, as are well known to those skilled in the art.

The mobile terminal 200 communicates with a cellular tower 210. The nature of communication is wireless, and the protocols used can be of a variety of technologies, including, but not limited to paging, cellular mobile telephony, digital cellular, PCS, GSM, GPRS, et cetera. Typically, a wireless service provider has a plurality of base stations or towers located throughout a serving area and a mobile terminal is usually in communication with a single tower at a given time (although exceptions occur during handoffs). The tower 210 is operatively connected to a mobile switching system (MSC) 215 that is a switch establishing and terminating various forms of communication with the mobile terminal 200. The communications include voice communication, signaling, and data. The mobile terminal may establish voice calls with wireline telephones or other wireless telephones. The operation of the MSC is also well know to those skilled in the art of mobile communications.

The MSC 215 is operatively connected to an Adjunct Processing System (a.k.a. “adjunct”) 220. The use of Adjunct Processing Systems is also well known to those skilled in the art of mobile telecommunications, and is frequently used to provide ancillary services to wireless subscribers. The adjunct allows deployment of a service by programming the adjunct and avoids modifications to the MSC service logic capabilities. Frequently, once the MSC processes signals and establishes communications, it may route the communication to an Adjunct Processing System for additional processing. Because of the size, complexity, and wide-scale deployment of MSCs, software changes require careful development and testing to insure that any modification occurs properly. Further, since such development is expensive, initial deployment of services to trial their viability frequently is accomplished using Adjunct Processing Systems. Also, adjuncts are often used when the processing involve is not directly related to the other system functions on the MSC. For this reason, the use of adjuncts is an economical and preferable method of implementing new services compared to modification of the MSC. Frequently, over time, if the service is highly desirable, the service may be integrated into the MSC. Thus, although the embodiment illustrated uses a separate Adjunct Processing System, the scope of the present invention also embodies integrated implementations or implementations which are variations of the illustrated embodiment.

The interface between the MSC and the Adjunct Processing System may involve voice channels as well as data channels for the communication of voice and data respectively. In some of the embodiments illustrated, no voice channels are required to accomplish the illustrated service, but in other embodiments illustrated, voice channels may be involved.

The Adjunct Processing System 220 comprises a processor 225 accessing primary memory (e.g., solid state memory such as RAM and/or ROM) 228. The processor also accesses a secondary memory in the form of a database 230 on a disk system that provides long term storage for programs and data. The adjunct is also operatively connected to an Information Service Provider 235. This interconnection may occur using a variety of technologies, such as dedicated communication facilities, switched communication facilities such as X.25 or frame relay, or preferably, the Internet. Although not shown, a communications controller may be used to facilitate communication to/from the processor with external entities.

The operation of the components of the Adjunct Processing System depends in part on the service involved and the functionality provided by the Information Service Provider 235. It is assumed that a relationship is defined between the Adjunct Processing System and the Information Service Provider so that the desired information is provided according to mutual protocols. The type of information provided by an Information Service Provider may vary and involve a single service or a multiple of services. The Information Service Provider “ISP”) provides information, frequently in the form of a graphical map for at least one type of service, such as locations of various items of a common type (e.g., stores of a certain type, locations of buried utility vaults, locations of police precinct stations, etc.). In some services, the information may be fairly static—e.g. the locations of public service facilities, business locations, utility vaults, etc. The Information Service Provider 235 may receive external inputs as necessary to formulate the information as appropriate (e.g., a map with the appropriate business locations). It can be assumed (for many services) that the Information Service Provider will update the map as necessary. The ISP may incorporate a variety of Geographical Information Systems (GIS) for various applications and vendors are readily available for providing such information or access to databases containing such information. After forming the map, the Information Service Provider 235 transfers the map via data communication to the Adjunct Processing System 220. The information may be obtained by the adjunct by requesting the information from the ISP, periodic polling, etc. The Adjunct Processing System stores the graphical map in the database 230 and may load it into memory 228 as necessary. When a user requests the information, the Adjunct Processing System retrieves the map from the database 230 and loads it into memory 228 (if not already present in memory), processes the data, and then sends the information to the MSC 215 for transmission to the user.

The adjunct may also store the map in main memory 228 for faster response time. Whether the information from the Information Service Provider is stored in main memory or secondary memory depends on a variety of factors, including the amount of memory required, desired response time, frequency of use, etc. Such techniques of determining how to cache information between main memory and secondary memory are well known in the art of computer science. Various alternative mechanisms for storing the information in an efficient manner are possible. For example, the Adjunct Processing System may store a graphical map of a city that is served by the MSC. The information regarding the locations (e.g., business locations, public service facilities) are stored in the database 230 and loaded into memory 228 when required. This allows the graphical map to be stored in primary memory 228 and only the geographical locations (of which there may be less than 100 locations in a given metropolitan area) are stored in secondary memory 230. The loading of the locations is then overlaid on the map in main memory providing a balance between efficient use of resources and response time.

On the other hand, the user may be requesting data that is dynamic and time sensitive. The data must be determined in real time for each request (e.g., traffic conditions, weather maps), the Adjunct Processing System may request the graphical information from the ISP 235 for each request. The ISP 235 determines the real time graphical information and provides it to the Adjunct Processing System upon request that stores it in memory 228 for immediate transmission to the MSC and then to the user 200. The Adjunct may retain the information in memory 228 for a limited time, during which the information retains its time sensitive ‘value’ and avoids duplication of the request should another user request the same information shortly thereafter. In the illustration of providing real-time traffic information, the adjunct could retain the information for a short time (e.g., 5 minutes) and then discard it once it is deemed ‘old’. Alternatively, if the usage history is known and warrants frequent updating in main memory, the adjunct may simply periodically request updated traffic information from the ISP 235. Various alternatives are readily apparent for the requesting, processing, and storing of data between the adjunct 220 and the ISP 235.

It is possible that the Adjunct Processing System and the Information Service Provider may be integrated into one system, but the preferred embodiment for at least some services is to have the ISP separate from the adjunct. FIG. 2B illustrates one embodiment for accessing a plurality of Information Service Providers. In this arrangement, the MSC 250 connects with the Adjunct Processing System 255. The adjunct in turn interfaces with the Internet 253 using the standard TCP/IP protocols and HTML, XML, or other Internet based protocols to operatively connect to a plurality of Information Service Providers 260 that can be located in distant geographical locations. This embodiment allows the Adjunct Processing System access to disparate Information Service Providers that are likely to be separate business entities from the wireless provider, by establishing a business relationship with the ISP. The wireless service provider can provide a variety of location dependent information download services to the user by using a variety of information providers.

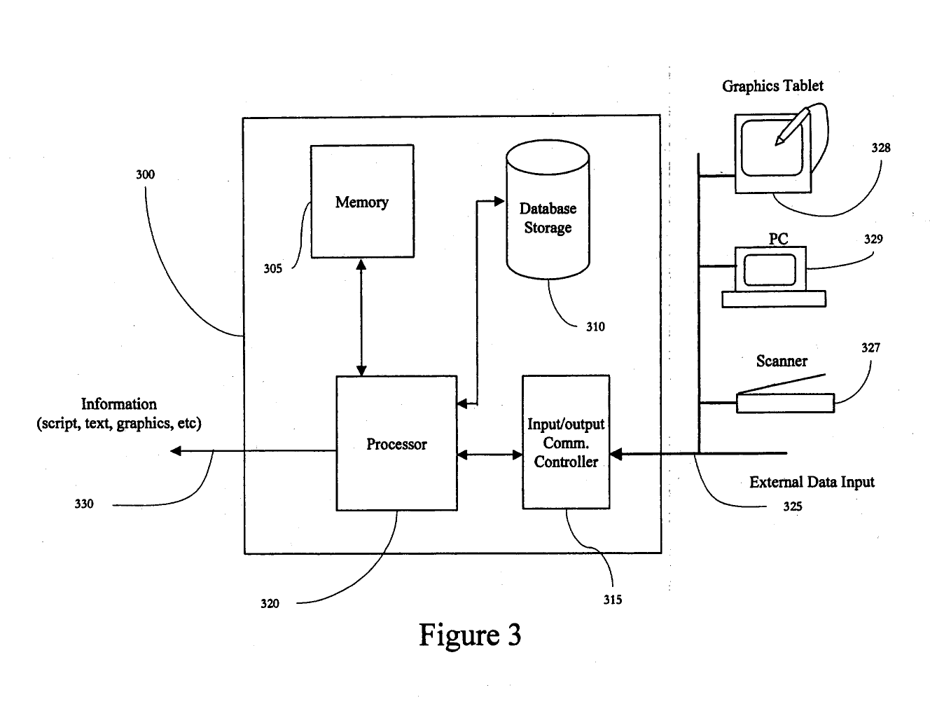

An embodiment of the Information Service Provider is illustrated in FIG. 3. The Information Service Provider 300 comprises a processor 320 operatively connected to a memory 305 and a database storage device 310, preferably implemented on disk storage, such as a magnetic or optical read/write disk system. The processor 320 is also operatively connected to an input communications controller 315 that controls external input and output. The external input devices comprise a variety of sources. These include digital files provided from other sources and loaded onto the database 310, graphics tablets 328, data from databases on external computers 329, and data obtained by scanning or digitizing documents user a scanner 327. The type of input device varies according to service application. For example, information provided to a user regarding the location of utility components (e.g., water valves, cable vaults, pipelines, etc) may depend on scanning or digitizing previously drafted maps using the scanner 327. This produces a digital image of the map that comprises part of the information download to the user. Other applications may involve the indication of locations such as business locations (hotels of a certain brand, utility locations, bank branches, etc). The locations may involve the use of a graphics tablet 328 for indicating locations from a map. The information is stored in a file in the database 310. Other information that is downloaded to a user may be obtained by processing data inputted into a PC 329, e.g. a list of movie theater showing times and prices.

It is anticipated that in many instances the Information Service Providers will be separate business entities from the MSC operator, and a contractual business relationship between the MSC operator and the Information Service Provider facilitates the information required to provide services to the user. Further, it is anticipated that a variety of ISPs will be accessed by the MSC for a variety of information types.

Absolute and Relative Location Determination

When the mobile terminal provides GPS coordinates to the wireless network, the coordinates are used by the network (i.e., the adjunct) to determine the location of the user. Either the network or the Information Service Provider (based on implementation options) can determine the location from a service perspective in one of two ways. These two types of location determination are called Absolute Location Determination and Relative Location Determination. As will be seen, different embodiments of the invention will use these different types of location determination.

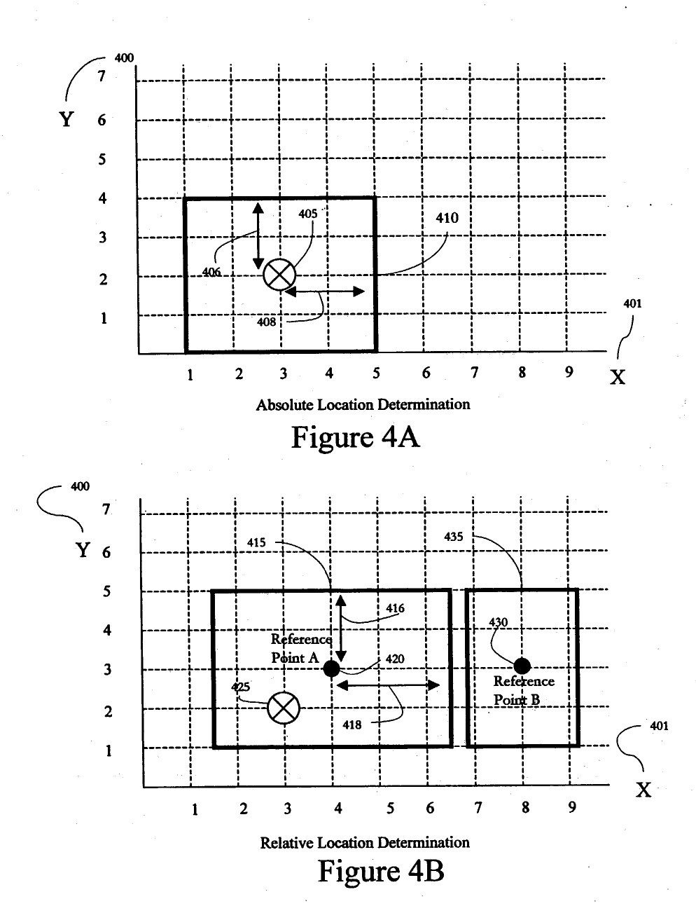

FIG. 4 illustrates these concepts with FIG. 4A illustrating Absolute Location Determination and FIG. 4B illustrating Relative Location Determination. In both figures, an X-axis 401 and an Y-axis 400 represent a grid representing longitude and latitude. In this illustration, X and Y coordinates are used to facilitate representation of the concept, and do not necessary correspond to the method of implementation. In FIG. 4A, the user coordinates are used to map the user's location on the grid, shown by a circular icon 405. Once the mapping of the user based on the GPS coordinates is accomplished, the absolute location is determined. In other words, the GPS coordinates are the absolute location. However, it is often beneficial to determine a boundary zone around the user's location for service purposes. A box 410 in which the user's location 405 is in the center illustrates this. The distances vertically 406 and horizontally 408 from the user's location that determine the boundary zone 410 are determined based on the service involved. Alternatively, the service provider could establish boundary zones as a circle with a given radius from the user's location, or any other shape including hexagons. Determining the boundary zone is service specific, and is used by the application to ascertain the area involving information to be downloaded to the user. For example, the user may request traffic information pertaining to their current location and the service provider could establish a boundary zone for ascertaining relative traffic information based on the user's absolute location. In this application, the boundary zone may be several miles long. In another service example, the user may request locations of nearby electrical power components, such as transformers affixed to power poles. In this application, the boundary zone may extend several hundred yards.

FIG. 4B illustrates relative location determination. Again, a grid is used to represent a map, and the user's location is again represented by an icon 425 based on the user's GPS coordinates. In this case, the location of the user from a service perspective is not the absolute location, but the location of the user based on the closest reference point 420 or 430. The reference points are established by the network to facilitate service operation. They can be used to represent discrete information download contents or services. In this illustration, the user 425 is closer to Reference Point A 420 rather than Reference Point B 430. Alternatively, the service provider may define boundary zones for Reference Point A 415 and Reference Point B 435 which are defined by a defined vertical distance 416 and horizontal distance 418 from the Reference Point. Alternatively, other shapes such as circles or hexagons, squares, etc. can be used. Thus, the relative location of the user is associated with the location of Reference Point A 420.

Relative location determination is used by some applications in which the user's absolute location is associated with another location for purposes of determining the information to be downloaded. In other words, the absolute location of a user is used to find the nearest reference point. For example, assume the boundary zones in FIG. 4B could correspond to a retail business property locations. Specifically, the boundary zone 415 around Reference Point A 420 corresponds to a retail location. When the user is present within the boundary zone, information is presented to the user that is associated with the business at that location. Should the user move to the boundary zone of Reference Point B corresponding to another business, information downloaded to the user is associated with the business at that location. Thus, for purposes of service operation and determination of the information to be downloaded, the ‘location’ of the user is a relative location of the reference point. This reference location is used to identify and structure the information, not the absolute location.

The use of the boundary zones varies based on the application and can represent vastly different sizes—e.g., from a few yards to several miles. Further, the above are concepts useful in illustrating the principles of the invention and do not limit the implementation of those service or application of the principles.

User-Specific and Generic Location Dependent Information Download

Two types of information download are define—user-specific and generic. These may correspond to two types of signaling messages from the user to the network as well as corresponding to different types of services. The concept of categorizing the type of information download is useful for illustrating various principles of the invention and is not intended to limit the implementation. The user-specific information download request and associated information transfer are also known as “user-specific requests” (or generic request) and “user-specific downloads (or generic downloads) depending on whether the request or the download is the emphasis.

User Specific Location Dependent Information Download

The user-specific request requires the user be identified. This can be done by a variety of methods, but usually relies on the telephone number (also called the directory number) of the mobile user to be signaled to the network to identify the user. Depending on the technology involved, other unique numbers can be signaled from the user to the network and used to identify the user. Other wireless technologies such as pagers, PDAs, wireless data devices, which use non-telephone number addresses, also fall within the principles of the present invention. These devices may use other proprietary or standard address schemes for identifying the device or user. Regardless of how the user is identified, the determination of the information to be downloaded is dependent on the subscriber making the request.

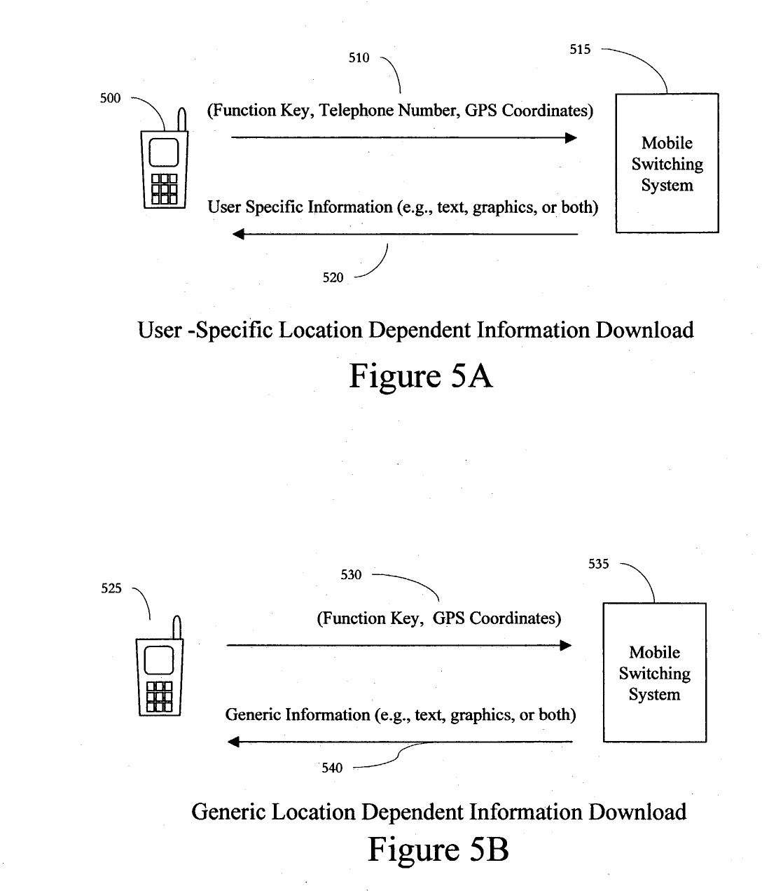

FIG. 5A illustrates the signaling between the mobile device 500 and the Mobile Switching System 515. The information to be signaled for user-specific location dependent information download typically comprises a function key, telephone number, and GPS coordinates 510. The function key (often designated as Fx or F#x where x is a number) is defined to be a programmable function, e.g., additional information in the user's service profile is required to interpret the meaning of the key. In other words, the signaling protocol does not attach any fixed service definition. In this manner, the function key indicates a particular function is requested and that information in the service profile is required to process the request. The function key can also be a series of existing keys (e.g., “*5”). The telephone number (also known as directory number) is the telephone number of the mobile device. This assumes that the mobile device has a telephone number assigned to it. Other, non-voice devices (e.g., pagers, PDAs, mobile data terminals) may not have a telephone number as they rely on a different addressing scheme. Finally, the GPS coordinates, typically representing longitude and latitude that represent the mobile device's location are also included.

The information could be sent in a variety of ways. The IS-41 protocol used for mobile-network signaling could be the basis for conveying the information. A variety of existing messages could be adapted or new messages created to convey this information. Other standard mobile-network signaling for data services can be used or adapted as well. For example, circuit switched data (CSD) could be used to establish a connection over which the information download request is made and over which the information download is received. This is a connection oriented data transfer, and for a variety of reasons, a connectionless data transfer protocol is preferred. One such protocols is known as Short Message Service, provided by many GSM-based wireless service provider. Short Message Service allows up to 160 characters of data to be transferred without establishing a circuit switched connection. Another protocol that could be adapted is Cellular Digital Packet Data (CDPD) that provides higher throughput connections. This is currently deployed by some cellular providers. However, protocols such as General Packet Radio Service (GPRS) and Universal Mobile Telecommunications System (UMTS) are more advanced as they as designed for third generation (3G) wireless deployment. These, as well as other wireless protocols such as the IEEE standard 802.11 commonly used in Wi-Fi applications, could be adapted to convey the signaling information and information download. Based on the particular implementation, various user operative aspects may be involved, e.g. some systems may require pressing the ‘send’ key afterwards, some devices and/or systems may not require this.

The network responds with the appropriate use-specific signaling 520, which can encompass a variety of data types. As some of the embodiments illustrate herein, text and/or graphical information can be sent. This can use existing protocols, such as wireless web HTML based protocols for conveying information, or may transmit images using standard protocols, such as JPEG, TIFF, bit-mapped data, et cetera. A variety of protocols or methods can be adapted and the preferred protocol depends on the information to be provided and the bit rate of the data service. For example, using a Short Message Service like connectionless service would accommodate a simple ASCII information response. A higher mobile-web based protocol would accommodate more sophisticated graphical information downloads.

FIG. 5B illustrates the generic information location dependent information download signaling. It is very similar to the user specific, but the mobile device 525 is not required in the request 530 to send the user's identification to the MSC 535. The MSC then responds with the information 540.

The distinction of user-specific and generic can be distinguished on the basis of whether the telephone number is present. Alternatively, the service provider could define certain function keys as user-specific (e.g., F1-F9) and which require the indication of the telephone number. Other function keys, (e.g., F10-F19) could be defined as generic, and not require the presence of the telephone number. If the telephone number were provided (which may be desirable to have consistent signaling procedures by the mobile handset), the network could ignore the telephone number if were not required for the service operation.

Alternatively, explicit indications could be included in the protocol, if required, to distinguish between the two applications. This varies as to how the wireless service provider defines the use of function keys, the ability of the mobile handsets to signal such information, service requirements, human factors in designing the service, et cetera.

A typical application of user-specific location independent information downloading is providing subscription-based services to the user. In a subscription based service, the user elects to receive a particular type of location dependent information and this requires the network to identify the user. By definition, subscription based services provide service only to a limited subset of users and do not provide the service generally to all subscribers. Thus, identification of the user is required. Although subscription based services often are associated with charging a fee to the subscriber, this is a business requirement, not a technical requirement. The network may offer non-fee-based services, while allowing the user to customize the nature of their service request. This, again, requires identification of the user to provide the appropriate information.

Typically, the association of service with the user is accomplished by the network examining subscriber data stored in the memory. The subscriber data includes information organized in a service profile that identifies the services associated with a particular user. In telephony applications, the subscriber's profile is indexed by the subscriber's telephone number. The wireless service provider usually maintains a subscriber service profile for each user, even if that profile indicates a minimum of services.

User-specific requests may involve both with absolute and relative location based services. For example, assume a user has elected to receive traffic information based on their current location. Since the user has elected to receive this information, this could be viewed as an example of a receiving information on a subscription basis. Since receipt of the information is predicated on the user's location, this is also an example of providing information based a user's absolute location. If the information provided was based on a nearby location for the specific user, this would be viewed as being user-specific and based on relative location of the user.

Generic Location Dependent Information Download

The generic request describes the scenario when the service request and information download does not require identification of the user making the request. Generic services are usually utilized when all users making the request for information receive the same requested information. Services which are subscription based are generally not generic based. Also, services, which are customizable by the user, are usually not generic, though examples can illustrate scenarios, which could be considered generic.

Frequently, generic information download is used when a business at a given location desires to make certain information available to any user making a request for information. For example, the network may download information about a business (e.g., telephone contact number, hours of operation, etc.) to users making a generic request for information at that business location. Such services make rely on the business paying the service provider for providing the information (e.g. similar to advertising). In this type of application, the user is indicating “here I am, send me whatever information you have” and the service provider responds with information associated with the business.

Finally, there are service scenarios that are considered hybrid, as they do not clearly fall within a single category. For example, some services may be provided to all subscribers, but which still require the user's identification. A wireless service provider could define a single function key as identifying the same service across their network for all subscribers. One embodiment is a generic information service that provides information to a user about movie showings at a movie theater with the option of ordering tickets. The purchase of a ticket by a user requires identification of the user if a credit card is being used. This service could be considered as user-specific since the user's identification is provided; but the service of providing movie information could be viewed as generic, e.g., the information is not unique to the user. In such cases, the categorization of the service is not critical, as the concept of categorization only illustrates the principles of the invention and is not intended to limit embodiments of the invention or constrain the implementation.

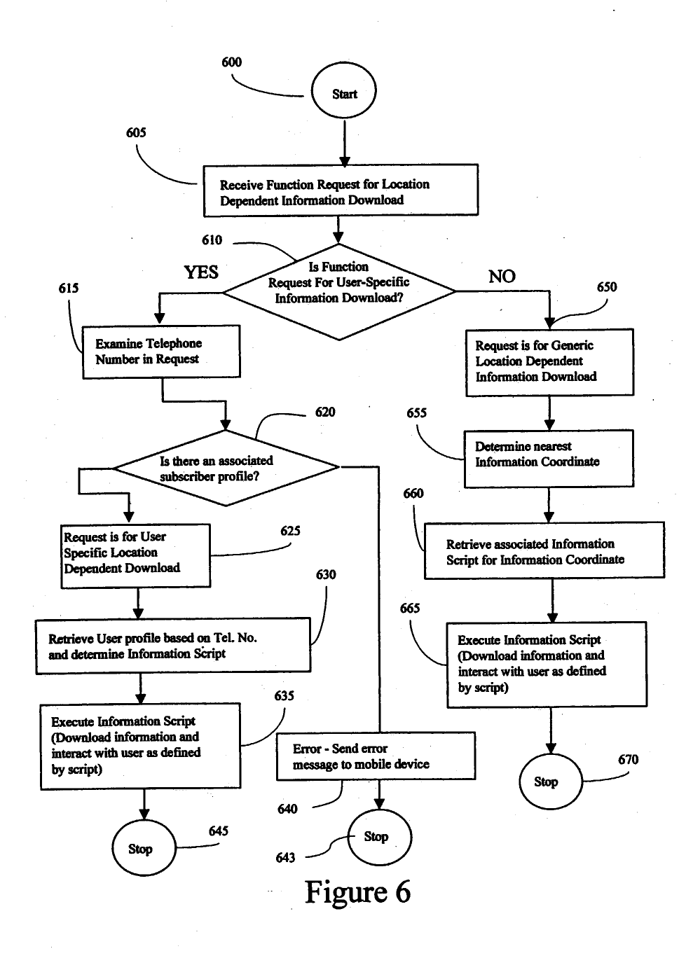

The overall processing in the MSC for the two types of information requests is different. FIG. 6 illustrates the initial processing by the MSC to determine the type of request indicated and the associated processing. Starting with block 600, the MSC receives a request for location dependent information download 605. This may be in the format as indicated in FIG. 5, or may use other variations of the protocol based on FIG. 5 or other protocols. The contents of the request are parsed to determine whether the function requested is user-specific or generic. Preferably, this is determined by the presence of the user telephone number. However, in some embodiments the service provider may define the same function for all users based on the function key definition and/or the user telephone number. For example, certain function key values could be defined as generic, whereas other could be generic or user specific based on the presence of a telephone number identifying the user. The request is examined to determine whether it is user-specific or generic 610. If the test result is ‘no’, then request is not user-specific, but rather generic 650. The processing assumes that the generic service requested is not subscription based. In this embodiment, the processing of the request further assumes that information regarding the nearest information reference point is desired 655. Once the nearest reference point coordinate is determined, the associated information script is retrieved 660. The information script may incorporate instructions as well as text, graphical, audio information and/or a combination of instructions that is sent to the user without any subsequent interaction, or it may result in information sent with the expectation of a user response. The script is executed 665 and the operation that occurs is based on the script. The process then completes in block 670.

If however, the request is user-specific as indicated by the ‘yes’ branch at block 610, then the user identification must be determined. Usually examining the telephone number in the request 615 does this, although examining other information that maps to the telephone number may do this. If there is no subscriber profile present for the indicated directory number, then an error has occurred and an error message is sent to the user 640 and the process terminates 643. Assuming a subscriber profile is present, the request is determined to be a valid user-specific request for location dependant information 625. The next step is to retrieve and execute the information script for the associated function key 630 and then execute the scrip 635. As this point, the interaction between the user and the system is defined according to the script and when completed, the interaction or download terminates 645.

In the above cases, the information script is a sequence of program steps and information that is downloaded to the user. The program steps indicated how and what information is presented to the user. Because the information script can define any number of possible steps, the script itself defines further interactions with the user. This can be implemented as a series of linked information screens. The script can range from a one-time information transfer to interactive information exchanges between the user and network.

Illustrative Embodiments

An application of the above concepts will illustrate an embodiment of the present invention. The service illustrated is a real-time traffic status display that indicated traffic congestion on a roadmap. The traffic status displayed is in graphical form and is designed to provide traffic status of a limited area centered on the location of the user making the request. A typical application of the service is to provide traffic conditions to drivers in cars equipped with mobile display devices. This could be a mobile telephone with a graphical display or an automotive computer with integrated display device in a dashboard. The service allows the user to obtain real-time traffic information based on the user's current location.

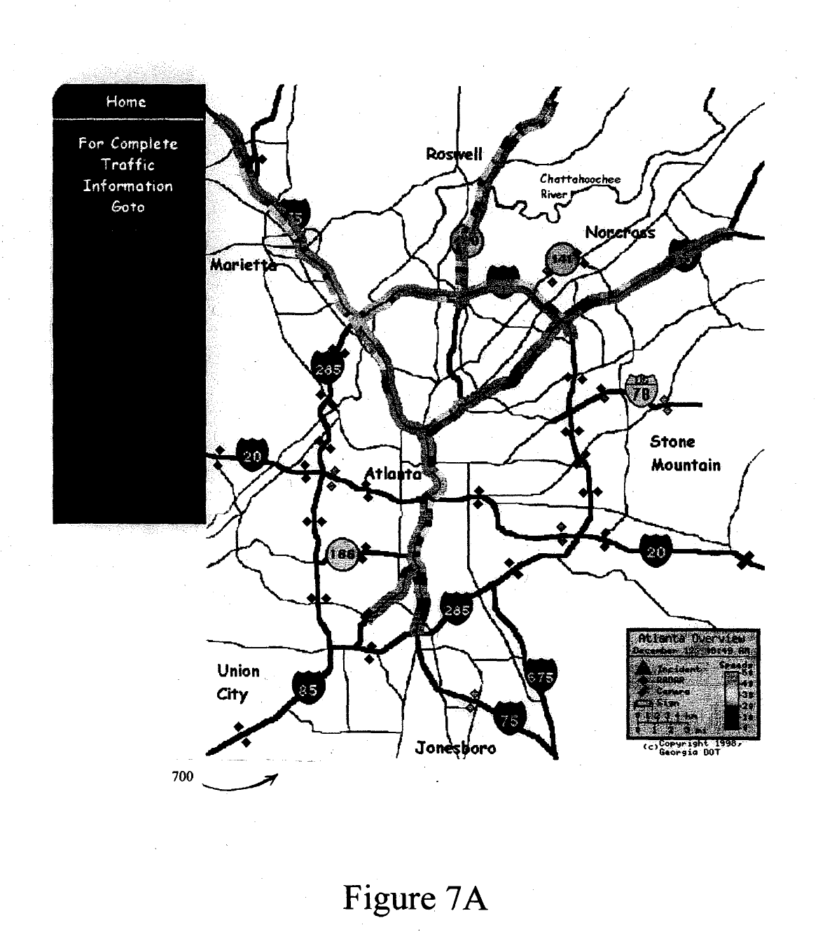

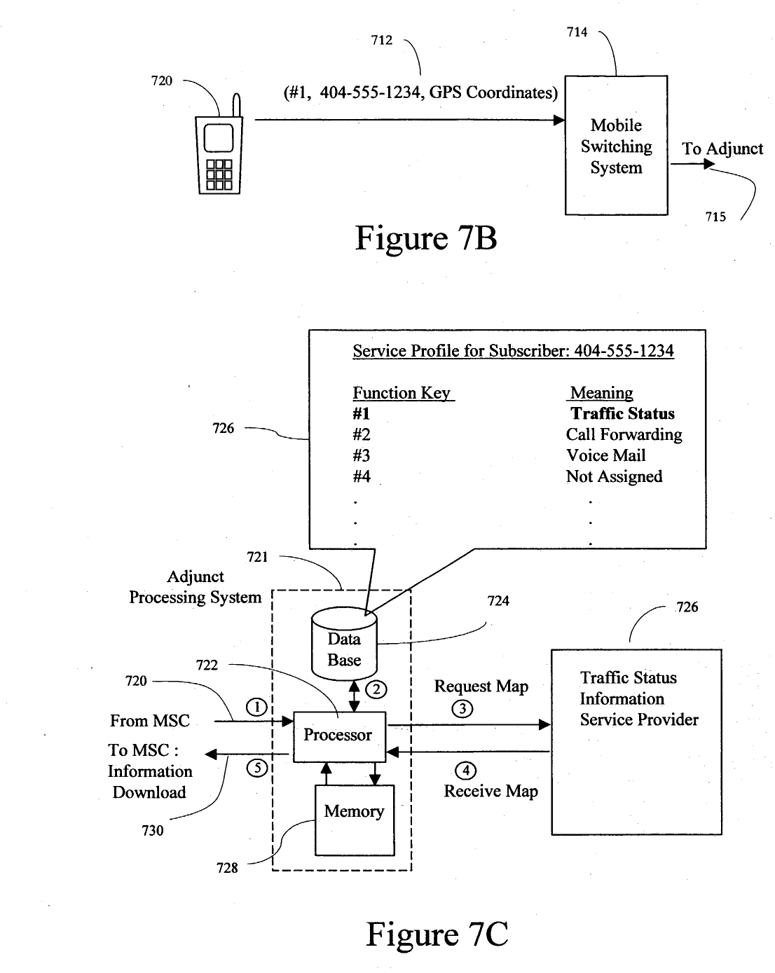

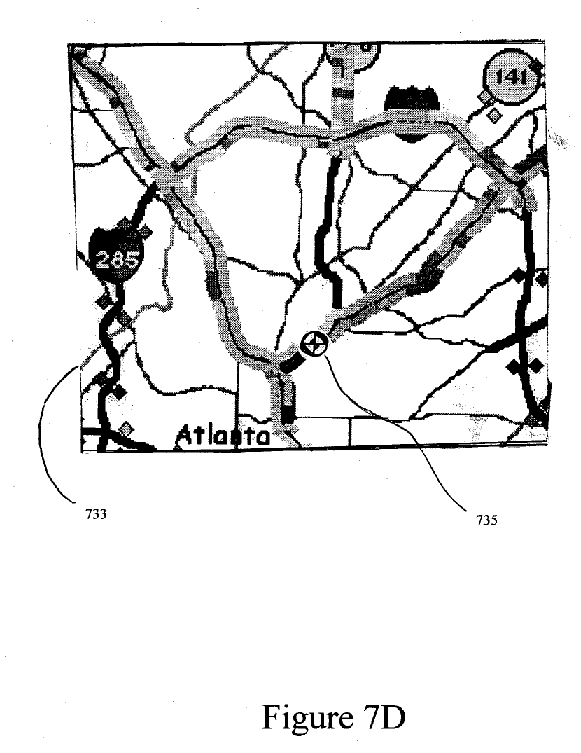

Currently, real time traffic information is available from a variety of Internet web sites. FIG. 7A illustrates a sample page from a site operated by the Georgia Department of Transportation providing real-time traffic status. A variety of sensors and inputs are processed by the entity to produce a map representing traffic flow and identify areas of congestion. In this type of service application, it is envisioned that the wireless service provider would contractually arrange to obtain information as necessary from the Information Service Provider to download to the wireless subscribers. Thus, the Georgia Department of Transportation (or the entity contracted to provide this information) corresponds to the Information Service Provider 235 of FIG. 2. Alternatively, the wireless service provider may operate the Information Service Provider or even incorporate the functionality in the Adjunct Processing System.

This service is illustrated as a subscription service, although this determination is a business decision of the wireless service provider. Because it is a subscription-based service, only those subscribers authorized to receive the information may receive the information. Of course, non-subscribers can always initiate a request, but the request will be denied. Further, the user is requesting information based on their absolute location, not based on the nearest relative information reference point.

The process is initiated by the mobile subscriber initiating the information download request and illustrated in FIG. 7B. The mobile user 720 initiates a signaling request by including the appropriate information 712. In this example, the function key is #1; the subscriber's telephone number is 404-555-1234, and the GPS coordinates are provided as determined by the mobile device 720. The information is received by the MSC 714, which processes the information. In this example, the MSC routes all function key information download requests to the interface 715 operatively connected to the Adjunct Processing System.

Turning to FIG. 7C, the Adjunct Processing System 721 is shown. The steps are numbered and occur in order. First, the processor 722 receives the information from the MSC 720. The processor 722 next determines that subscriber information is required. This can be determined by a number of methods, including the presence of the telephone number in the request. The wireless service provider could further allocate some function keys to certain request types (e.g., F1-F9 as user-specific and F10-F19 as generic) The database 724 contains all the subscriber information and a service profile 726 is located for that subscriber as identified by the telephone number. The service profile contains a listing of the various function keys assigned and locates the function associated with the request (#1). Of course, if the subscriber profile or the function key definition is not located, an error message would be returned to the mobile device. In this case, the function key is associated with the traffic status service. The database contains information as to the location of the service script (not shown) and the script is retrieved and executed by the processor 722. The information script commands the processor to execute step 3, which is to request a traffic map from the appropriate Information Service Provider 726. The ISP may be, as previously indicated, a state transportation agency collecting and providing such information to the adjunct. The information is returned to the processor in step 4 and the processor may store the information in memory 728 and/or in the database 724. The processor then processes the information as necessary and appropriate to the format for the user and sends it in step 5 to the MSC for downloading 730. This may depend on the user's device and/or service characteristics and can be indicated in the service profile. The final result is shown in FIG. 7D where the graphical image 733 is cropped, formatted, and the location of the user is marked 735 using an icon so that the user may identify their relative position to the relative traffic flow.

Frequently, the adjunct processor must process the information to fit the size and resolution requirements of the display device. In the service example shown, the map is oriented so that the top of the screen represents the direction the user is traveling to and does not necessarily represent north. In other applications, such as in providing a real-time weather map, it is will customary to orient the map such that the top of the screen does represent north. Consequently, the appropriate orientation, format, scale, and size must be determined for optimal operation of the service.

The embodiment illustrated involves a one-time download of information transfer to the user from the wireless network. This is a relatively simple transfer of information (i.e., a minimal interactive format) and more complicated embodiments of the invention are possible. In the next embodiment, the user is present with location dependent information and selects a location represented on a map, signals the selection to the network, and in return, is presented another map wherein the processing is based on the previously indicated selection.

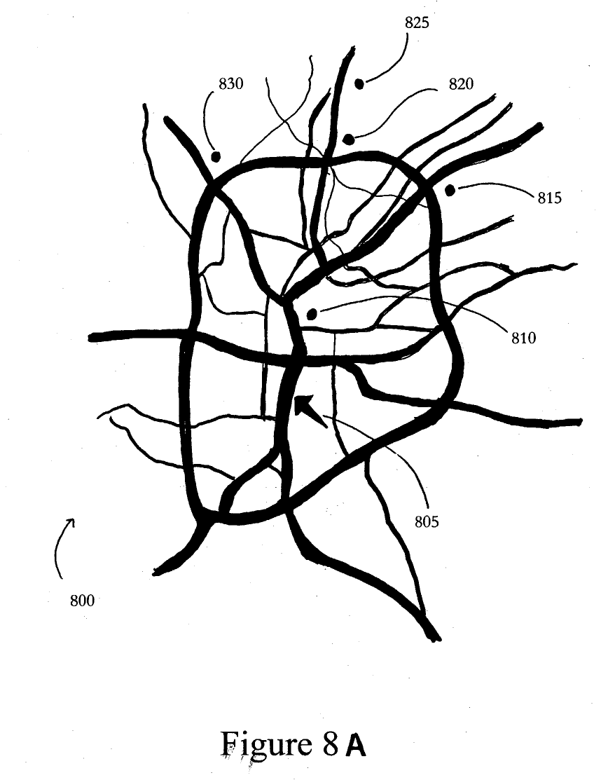

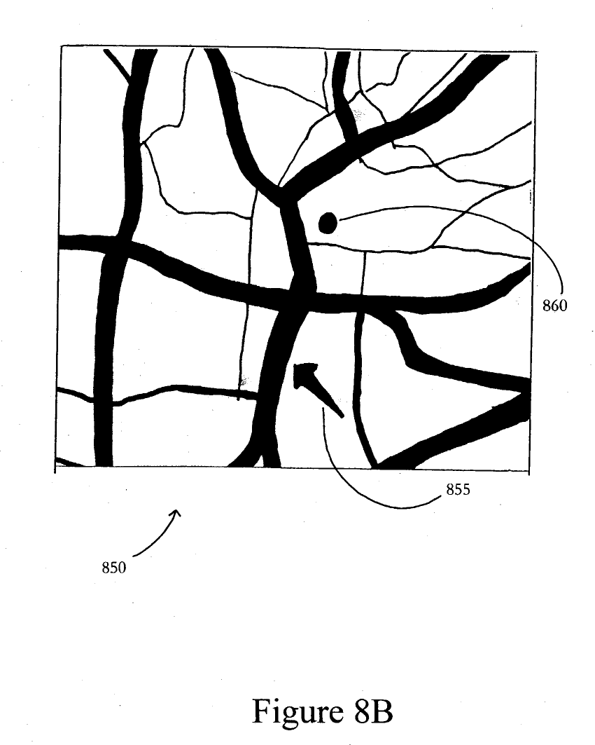

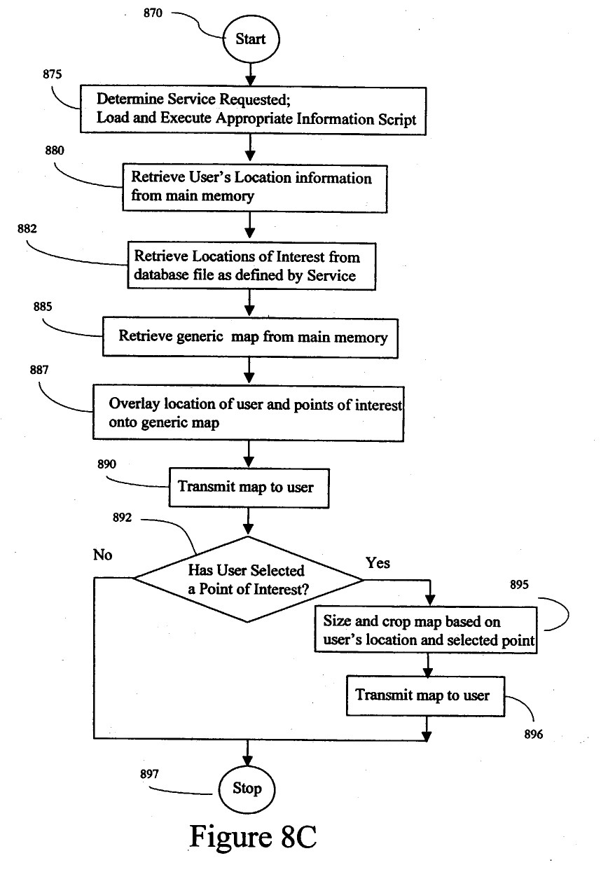

In FIG. 8A, a map is illustrated which has been downloaded to a user. The steps necessary to reach this point are similar to that previously discussed for the traffic status download. Specifically, the user has made a user-specific request to the network indicating the requested function, their telephone number, and GPS coordinates. In this embodiment, the information request is associated with a service that provides locations of nearby locations with a common attribute. These locations could be businesses of a certain type (e.g., hotels, gas stations, shoe stores, home centers) or of a certain brand or franchise (e.g., McDonalds®, Marriott®, etc.) or function (public safety, hospitals, entertainment complexes, shopping malls). The network determines the subscriber is entitled to the information and sends a request to the Information Service Provider, and receives a response and downloads the information to the user.

As shown in FIG. 8A, the map 800 is a roadmap map of a city (i.e., a roadmap of the Atlanta metropolitan area). The user's present location is indicated with a unique icon 810. The icon here is an arrow 805 that represents ‘you are here’. Other icons such as a circle with “X” could be used. The locations of points of interest (e.g., hotels of a certain franchise) are indicated by solid circles 810, 815, 820, 825, 830. The user is able to select a particular point of interest by one of a variety of commonly known techniques on the mobile device. For example, a stylus may used to point and select the point of interest, a mouse may be used to move a cursor over the point of interest, or in the case of some mobile devices, a ‘thumbwheel’ may be programmed to select a point on the screen, and move to the next point upon further turning of the thumbwheel. Once the user has selected the desired point of location or reference point, a message is sent to the network indicating the particular location.

Upon receipt of the message, the network determines that a larger scale of the map is desired with the user's location and the desired destination. This is illustrated in FIG. 8B. In FIG. 8B, the pertinent map 850 has been expanded and cropped. The user's location 855 is indicated with the same icon and the selected location is indicated 860. Depending on the location of the points of interest, other locations may be indicated on the expanded map, but such is not the case in this embodiment.

The implementation of this example can be efficiently realized by the Adjunct Processing System maintaining a generic map of the metropolitan area in main memory and overlaying the points of interest onto the generic map. This process is illustrated in FIG. 8C that is one embodiment of the invention. Starting at block 870, the process begins when a user initiates a location dependent download. The system determines the service requested and loads and executes the appropriate information script. The next block 880 reflects the start of the execution of the information script. The first instruction indicates that the appropriate location points are retrieved from a file in the database 882. This file stores the location information for a particular point of interest, whether it be businesses of a certain type, location of utilities such as cable vaults, or hospital locations. The information script will define the appropriate file to retrieve. Next, the information script indicates the generic map from main memory is required 885. This map is generic because it does not reflect any user locations or points of interest and can potentially be used for a variety of services. Next, the system overlays the user's location and the points of interest onto the generic information map to create the service specific map 887. The system then transmits the map to the user 890. The service script may indicate that this step completes the download process, or the information service script may allow further interaction. In this embodiment, the information server script waits a predetermined amount of time for the user to select a particular point of interest 892. If none is selected, the script is done 897. At this point, the system may delete the service specific map in memory, or if demand for such requests warrants, it may retain it in memory. If the user does select a particular location 895, then the information script defines the action to be performed. In this example, the map is increased in scale based on the user's location and the selected destination, cropped (i.e., portions of the map are removed) and the modified map is then transmitted to the user 896. The information download is then complete 897.

In this manner, a common generic map can be used for a variety of services without having to be recreated for each user and for each request, and only the points of interest are maintained. Upon determining that a larger scale image is required, the network can overlay the user's location and the indicate location on the generic map, size and crop the map as appropriate, and transmit it to the user. In this manner, information can be readily provided without repeatedly recreating and transmitting a complete graphical map from an external Information Service Provider.

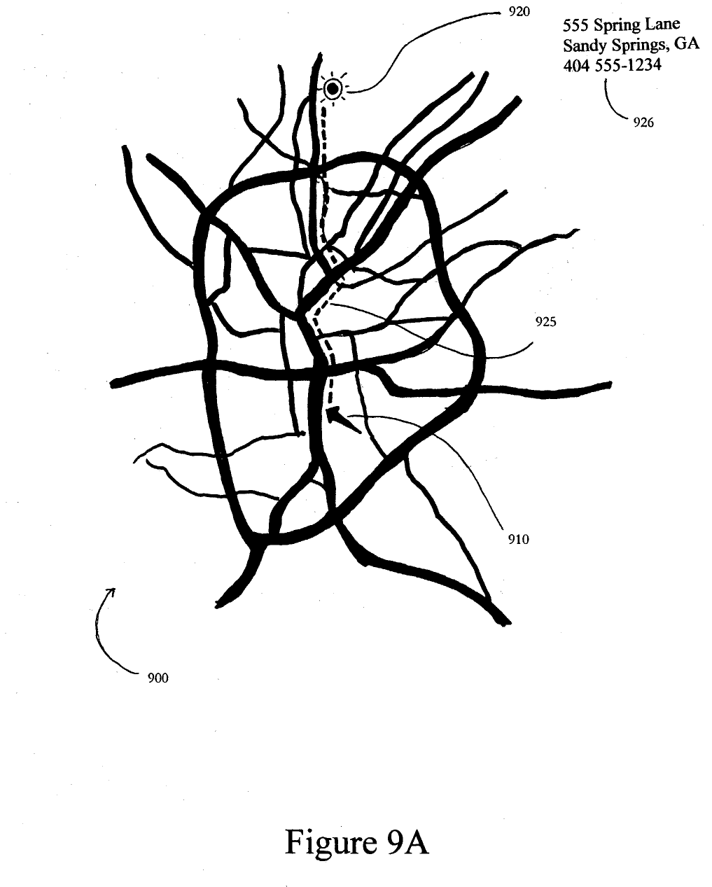

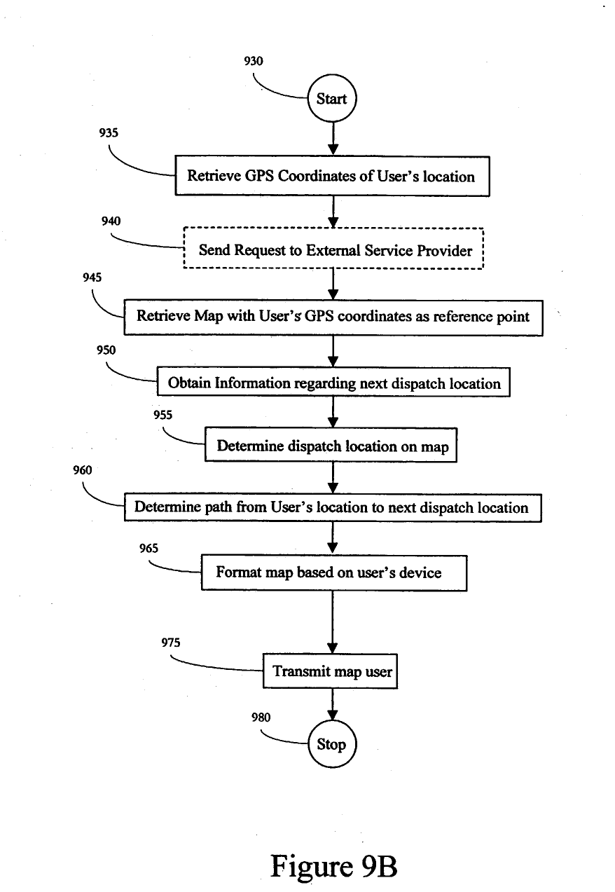

Another embodiment of the invention is illustrated in FIG. 9A. This illustrates a ‘dispatch’ service that indicates to a user the next location that they should proceed to. This service has applications in a variety of businesses, including the taxicab business, courier service, repair dispatch, delivery dispatch, etc. When the mobile user invokes the service, the user initiates a user-specific information download request and the network determines the service associated with the user. Based on an algorithm determined usually by an external Information Service Provider, a map 900 is generated as shown in FIG. 9A. The user's location is illustrated with an icon, shown here as an arrow 910. The next dispatch the user is directed to is shown with another icon, illustrated as a circular icon 920. The particular icons are for illustration only, and a variety of other icons could be used to indicate locations and routes including flashing symbols, animated symbols, or lines. The map also illustrates a suggested route 925 that the user can take to reach the indicated destination. Also indicated is text information pertaining to the destination's address and telephone number 926.

The processing involves in this service application is shown in FIG. 9B. This is only one embodiment, and starts with the execution of the user-specific download request 930. The location of the user as identified by the GPS coordinates are retrieved from memory. At this point, the next action involves sending a request to an external service provider 940. This action is shown with a dotted line to indicate that this is optional, and the information could be maintained in the adjunct. However, for many dispatch operations, the business operating the dispatch service (e.g., taxi cab) knows the next location for their agents, and the Adjunct Processing System that is typically operated by the wireless service provider usually does not maintain this information about the next dispatch location. However, the Adjunct Processing System can easily maintain addressing information for where to send the request of the next dispatch for the user. In this case, the request includes the identify of the user and their current location. A query is sent to the dispatch controller that can be done via an Internet based message to the Information Service Provider. The Adjunct Processing System will also retrieve a generic map from main memory 945 and overlay the user's current location using an icon, such as illustrated in FIG. 9A. The Adjunct Processing System then receives the location of the next dispatch location, typically in the form of GPS coordinates and potentially including text based address information 950. The information will be received from the external ISP if a prior request was made to the external ISP. This information is used to overlay the dispatch location on the map 955. Then adjunct then uses an algorithm to calculate the route from the user's current location to the dispatch location 960. Alternatively, an external Information Service Provider could determine the route based on the origin and destination points. Such algorithms may also take into account traffic and road availability considerations. The adjunct will format the map according to the user's device (e.g., scale, cropping, orientation, etc) 965. Finally, the system transmits the map to the user 975. In this embodiment, the information download is then complete 980. Of course, based on the information script, further interaction with the user can be defined.

Generic Information Download Requests

The aforementioned embodiments rely upon the absolute location of the user making the request in order to process the information to be downloaded. Embodiments are provided that rely on the relative location of the user to complete the service interaction. These are usually generic information download requests (‘generic requests’) and are triggered by the user signaling the appropriate service request along with their service location. The user usually does not indicate their telephone number, although in some applications this may be provided and used by the application. This service can be viewed as initiating an information download where the information is based on the user's location. The information download can actually be an interactive information exchange with the user, as defined by the service.

The generic download has applications where the user is situated at a given location, and information to be provided is associated with a nearby point of reference (geographical location). Frequently, this application is predicated on a business model where a business determines the information content provided to the user. Frequently, businesses may use this as a type of advertisement medium. However, the application is not limited to only business applications, nor it is limited to only advertisement. The user could use this as a portal into an information dialogue session with the information provider associated with that point of reference location.

For example, a user is located in front of a business and the business displays an icon in their store window signifying that information downloads are provided. A user present at the location sees the icon and knows to signal to the network provider for a generic download request. Based on the location, the network provider accesses the corresponding Information Service Provider who provides the corresponding information. A typical application is a user standing in front of a movie theater requesting information regarding movies being shown at the theater. Or, a patron of a museum can receive information regarding the operating hours. A visitor to a national park can request a download regarding information corresponding to a particular view. For example, while standing in front of a national monument, information regarding the monument can be obtained.

The generic request can operate with user identification. In this situation, the request is not for a specific function (so it is not user-specific), but it does require the user's identification to complete the dialogue. For example, a user standing in front of a vending machine may request a generic information download. The information downloaded comprises a message inquiring whether the user wishes to purchase an item from the vending machine. The user responds positively, indicating their user identification (if not previously provided in the initial request), and a signal is sent to the vending machine dispensing the product. The network uses the user's telephone number to identify the user, debit the user's account to pay for the purchase. The operation of these services will become clearer in light of the following examples.

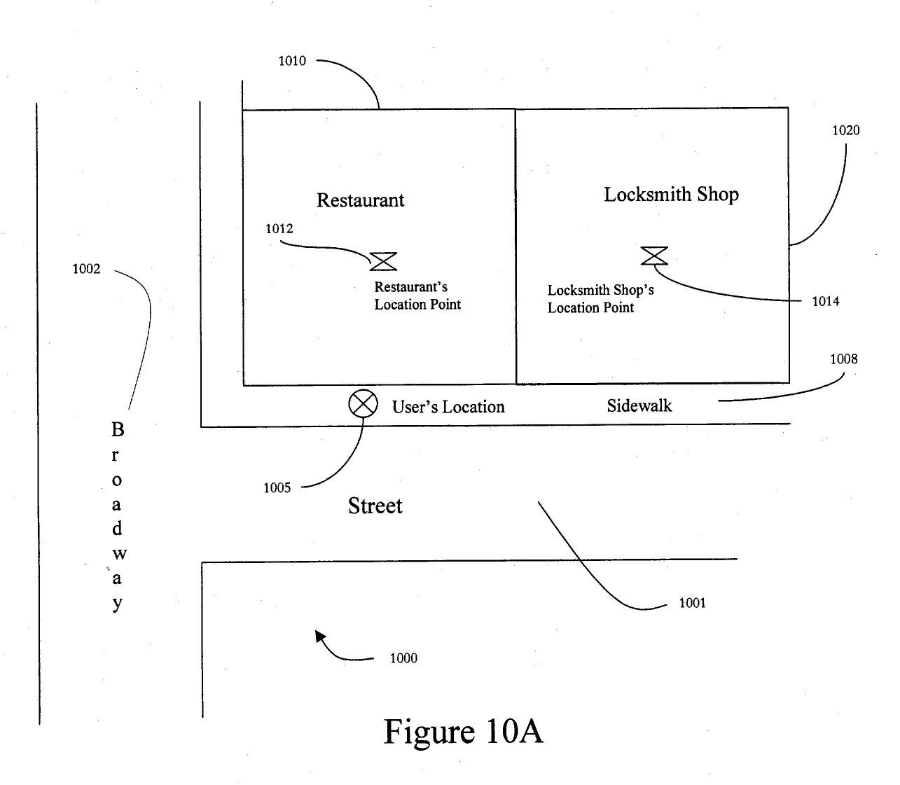

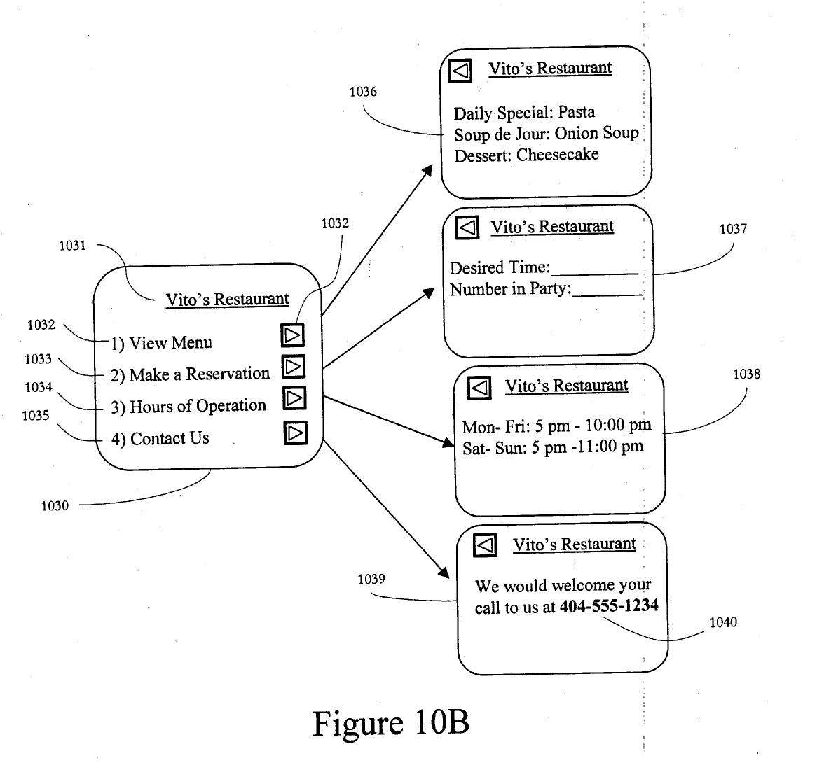

An embodiment of a generic service is illustrated in FIG. 10A. In this service, a user requests information, but the exact nature of the information provided is determined by the user's service profile. FIG. 10A illustrates an aerial view of a city street comer/intersection 1000. Depicted are two streets, Main Street 1001 and Broadway 1002. At the intersection on one of the comers is a business, a restaurant 1010. Adjacent is another business, a locksmith 1020. A sidewalk 1008 is located at the entrance of the stores, and a user, depicted by an icon 1005, is standing in front of the restaurant. The user wishes to receive information pertaining to the restaurant, and initiates a generic location dependent information download request. The coordinates associated with the user's location are sent to the network, and the coordinates are compared with coordinates representing established reference points. For example, in FIG. 10A, a reference point 1012 is established for the restaurant 1010. This reference point which is typically located in the boundary of the property associated with the business, indicates that information is available for downloading associated with the business. Also indicated, is a reference point 1014 associated with the locksmith business 1020. The network will typically examine the reference points within a certain distance from the user's location and ascertain the nearest location point. In this instance, the restaurant location point 1012 is closer to the user 1005 than the locksmith's reference point 1014. Based on this, the network retrieves the information script for the restaurant, executes it, and downloads the information to the user. There are a variety of methods by which the appropriate reference location to the user can be determined.

The information script can be a one-time information page provided to the user. More likely than not, the information comprises text information, although graphical, audio, or combinations thereof could be sent. In this embodiment, the information provided to the user is textual and illustrated in FIG. 10B. In FIG. 10B, the information downloaded is presented as a list of menu options 1030 of the restaurant 1031. The user can respond by selecting an option. If the user selects the first option 1032, the user is presented with a new text based information download illustrating the menu items 1036. If the user selects the second option 1033, then the user is presented with a new text based menu requesting the time and number of persons in the party 1037. If the user request the third option 1034, the user is presented with information regarding the hours of operation 1038. If the user selects the fourth option 1035, then the user is presented with a text message 1039 indicating the telephone contact number 1040. In this instance, the telephone number downloaded 1040 is specially delimited in the information download so that it is displayed distinctly. Just as many modern word processing packages and email programs recognize an URL (universal resource locator) address from regular text (e.g., marking it as a URL so that linking to the appropriate web site can occur), the phone numbers in the text message of the information download are recognized as telephone numbers by the mobile device. These may be displayed with a different color or font. The user may select the phone number using the aforementioned techniques (e.g., selecting via a pointer, thumbwheel, touchpad, etc.). In essence, the ‘marking up’ of information in a information page (similar to HTML) occurs so that telephone numbers are identified as such to the mobile device. Once the device has selected the number, the user can ‘click’ on the number to dial the number. In this manner, contact information can be easily provided to the user as part of the information download that is recognized as such and facilitates use of the address information to contact the party. In this manner, a variation of directory assistance can be provided by standing near the location of the number that is desired. Of course, this could function on a text-basis using URL to access the business'web page. Once the communication is initiated, the information script may terminate, or may resume at the same point when the communication was initiated.

The recognition of the telephone number as an address could occur via text-based parsing in the mobile device, but a preferred embodiment is to define the information download using protocols techniques similar to HTML in which address information is specially indicated as such.

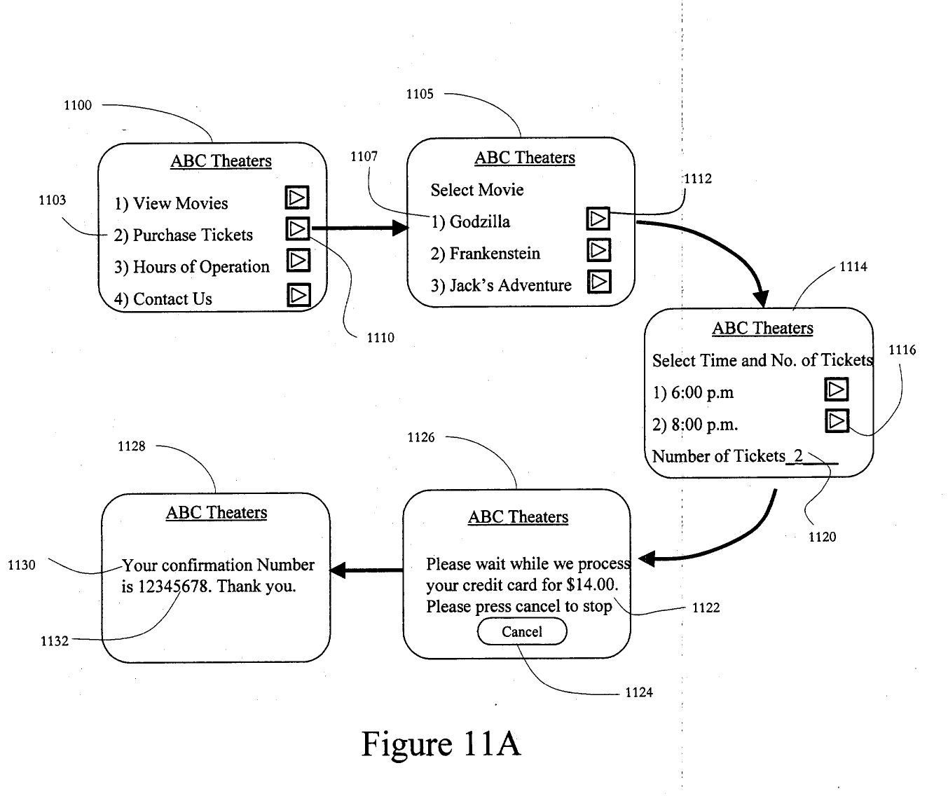

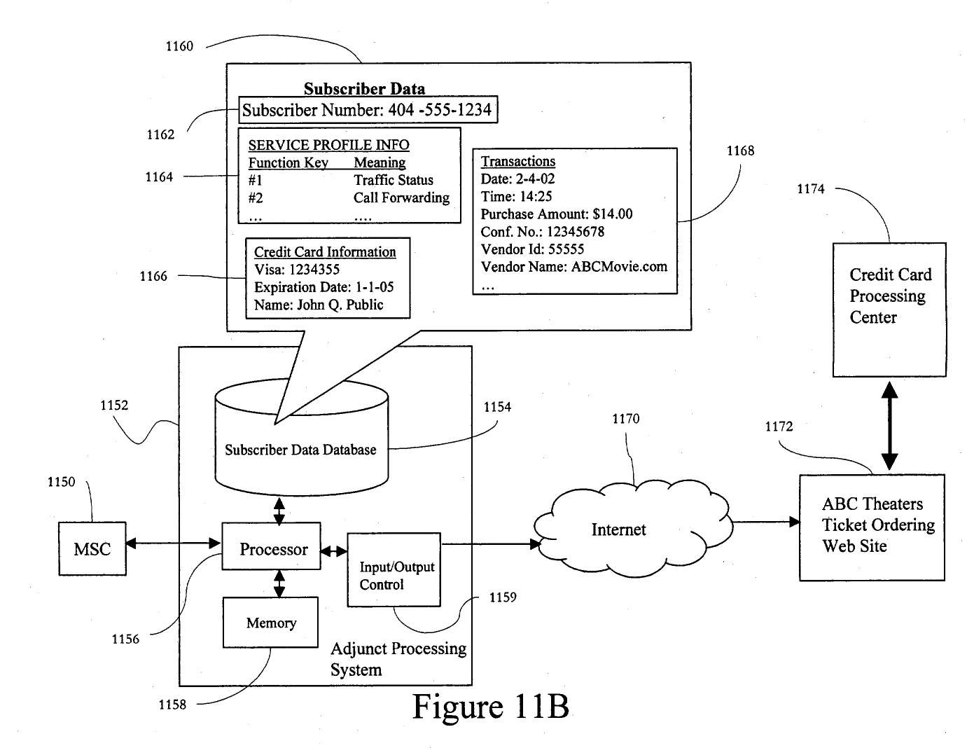

Other embodiment illustrates the application of the principles of the invention to allow a mobile user to purchase items using their mobile device. For example, a user could stand in the vicinity of a movie theater and in order to avoid long lines, purchase a ticket remotely. In FIG. 11A, an initial presentation of information downloaded is illustrated 1100. This may be obtained via a generic download request according to the principles previously defined. The information comprises a menu with various options, including an option for purchasing tickets 1103. The user selects this option by selecting the adjacent icon 1110 which signals to the service provider to download the next screen. Alternatively, the whole linked list of menus can be downloaded and the selection of the icon results in processing wholly within the mobile device. After selecting the icon 1110, the user is presented with the next screen 1105. This lists the movies playing, and the user selects the desired movie 1107. After selecting the icon 1112, the next menu 1114 presents the various times, and after selecting the movie by selecting the icon 1116 and the number of tickets 1120, the user is presented the next screen 1126 that indicates a charge is being processed against their credit card with the amount 1122 indicated. The user is also presented with the option of canceling 1124. Obviously, this and the subsequent screens must be downloaded from the service provider because they contain information that can only be determine after the initial screen. Assuming the transaction complete successfully, the next screen 1128 where the user is presented with a message 1130 and confirmation number 1132.

The provision of a confirmation or transaction number is important, as this may be the basis for verifying the purchase. For example, the user may indicate this number to the movie theater box office as a basis for receiving the tickets, or may reference this number for dispute resolution with the merchant. The system will retain the transaction information in the subscriber data memory storage, so that the user can review the transactions. The review of the transactions may occur via the mobile device, or alternatively, Internet access may be provided for the user to remotely and subsequently review the information.

FIG. 11B illustrates the systems and procedures embodying the service. In FIG. 11B, the previously defined capabilities for invoking an information download request are used and not shown. Rather, FIG. 11B illustrates the MSC 1150 in communication with the Adjunct Processing System 1152 that contains a processor 1156 for executing the various commands necessary for accomplishing the service. The memory 1158 stores the program and data associated with the information script. This may be loaded from the database 1154 if required. The input/output controller 1159 allows the adjunct to communicate with a variety of protocols with various Information Service Providers. In FIG. 11B, the adjunct 1152 communicates using TCP/IP protocols over the Internet 1170 to the Information Service Provider 1172. In this embodiment, the Information Service Provider is a processing system associated with the Movie Theater 1172. In turn, the movie theater ticket ordering system 1172 is operatively connected to a credit card processing center. The implementation details of the movie theater ticket ordering web sit 1172 and the credit card processing center 1174 are well known in the art.

Once the adjunct receives a request for a movie ticket purchase (see screen 1114 of FIG. 11A), it has the information necessary to process the order. The adjunct 1152 maintains a database 1154 that includes subscriber data 1160. Subscriber data is information that pertains to subscribers. It is typically indexed by subscriber telephone number 1162 which allows ready retrieval of information pertaining to a subscriber. If the subscriber or user is identified by another type of number, that may be used. The telephone number is illustrated in this embodiment as a mobile phone is presumed to be used, but other devices that are identified in other ways can be used.

The subscriber data include the subscriber service profile 1164. This includes information regarding what services are associated with the user. This was previous discussed in relation to processing information download requests. In this embodiment, one of the information download requests is used to invoke this service and indicated in the service profile as a generic download request (not shown). In order to process the order, the adjunct preferably maintains credit card information for the user 1166. Alternatively, the user could enter this information, but maintaining a record in the subscriber data database is more secure and facilitates user purchases.

The adjunct sends the purchase request to the web site address of the movie theater ticket-processing center. The adjunct maintains a list of addresses associated with the information script for the information download (not shown in FIG. 11B). This information is maintained in the adjunct in another database storing the information scripts that are downloaded (not shown). The processor 1156 formulates the request, and the I/O controller 1159 adapts the request to the protocols required to communicate it over the Internet 1170 to the ticket processing web site 1172. The ticket ordering web site processes the request and charges the indicated credit card using the credit card processing center 1174. The ticket ordering web site 1172 provides the confirmation number to the adjunct 1152 that stores the information in a transaction data area 1168 associated with that subscriber's data. The transaction data 1168 is stored allowing the user to review the information subsequently, using alternative communication methods, such as the Internet to access their records, or the user may review the details by using the information download request procedures.

In addition to storing the transaction 1168 in the subscriber database 1168, the adjunct 1152 also communicates the information to the MSC 1150 that in turn communicates it to the user (this step is not shown). In this manner, the final confirmation screen 1128 of FIG. 11A is provided to the user.

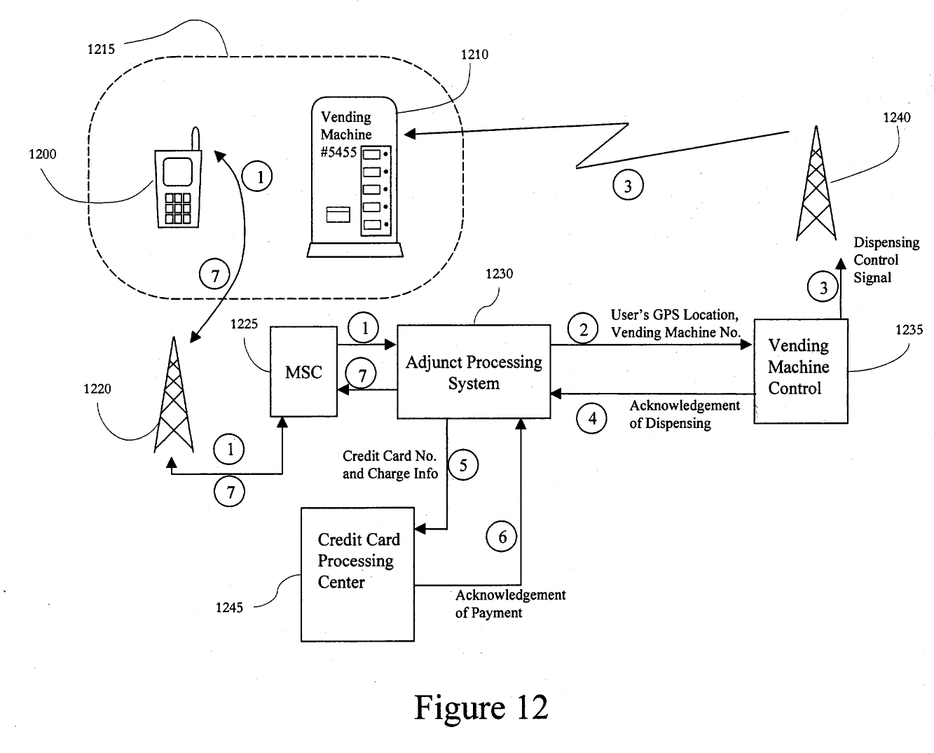

Variations of the invention related to purchasing products are possible and one alternative embodiment is illustrated in FIG. 12. This illustrates the application of the principles of the present invention to facilitate the purchase of an item from a vending machine, specifically a soda machine. In this embodiment, it is presumed that the vending machine is adapted for remote control to dispense the items.

The process begins with the user operating the mobile device 1200 in the near geographical vicinity 1215 of the vending machine 1210. The network will define a geographical area 1215 that is the boundary zone for the point of reference, which is the vending machine 1210. In this manner, fraud is minimized since it is not expected that a user would purchase an item from a vending machine if they were not located within close proximity. Further, to facilitate purchase, the user may include in their signaling request the vending machine identification number.

The mobile device initiates a generic information download request in step one using the previously identified procedures. The request is received by the wireless service provider's tower 1220 and sent to the MSC 1225. The MSC in turn determines the request should be processed by the adjunct 1230. Although not required, the adjunct may download information to the user that facilitates ordering the item. For example, if there are a plurality of vending machines, the information may allow the user to select which machine the item is to be purchased from. Alternatively, the information menu may solicit the user to enter the vending machines identification number that is prominently displayed on the vending machine 1210, if it was not previously provided. Further, the vending machine may also display an icon signifying that remote purchase of products is possible.

The adjunct examines the service profile of the user and obtains the user's credit card information. The adjunct then initiates a request in step two to the Vending Machine Control center 1235. It is presumed that there is a business relationship between the adjunct and the vending machine control centers, as these are likely to be separate business entities. The adjunct indicates the user's GPS location, or alternatively, the GPS location of the reference point.

The Vending Machine Control center 1235 may check that a vending machine at that location exists and is operational. It may also further process the credit card information. Alternatively, the adjunct may periodically send a single payment authorization for all of its subscriber's purchases to the Vending Machine Control center. Once the Vending Machine Control center authorizes the purchase, it initiates a command in step three that is communicated from a wireless transmitter 1240 to the vending machine 1210. A variety of wireless technologies may be used to control the vending machine, and it is not required that the same infrastructure is used for requesting and downloading information.

The Vending Machine Control center 1235 in step four acknowledges the dispensing to the adjunct, which may then trigger the billing of the user's account. The adjunct in step five may process the credit card information by communicating the required information to the Credit Card Processing Center 1245 and a response is sent in step six back to the adjunct indicating the credit card was charged. In step seven, the adjunct 1230 then communicates the acknowledgement back to the MSC 1225 that communicates it in the appropriate format to the appropriate user 1200.

This illustrates another embodiment for the purchasing of goods. In this embodiment, the adjunct maintains the credit card information and communicates with the credit card processing center. The adjunct, via a separate business arrangement, settles accounts with the vending machine operator. Those skilled in the art will recognize that other variations are possible with regarding to embodying a system for purchase of items.

Additional Applications

From the foregoing, it is apparent the invention can be used to provide location dependent information download to users wherein the information can be text based, graphical based, audio, or a combination of formats. The text based can be simple ASCII based strings of text or can be a HTLM based protocol for indicating text and formatting information. The graphical based information can be bit map, TIFF, or other standards for communicating graphical information.

Typical service applications include providing graphical information representing locations of certain physical of logical objects. For example, utility crews working on electric, water, cable, telephone, gas, or other type of physical facilities can use the present invention for downloading information pertaining to locations of valves, meters, pipelines, cable vaults, transformers, splice locations, et cetera. Emergency workers could use this to obtain locations of the nearest hospitals, police stations, fire stations, or other public works facilities. In addition, such users could be presented with graphical representation of the roads, cable plant, electrical power distribution plant, telephone facilities, et cetera for their area. Included can be real time indications as to the operational status for such facilities. For example, power company repair personnel could download a map of transformers for a given area that includes an indication of operational status for each transformer.

Individuals standing at a given location could retrieve public records, including tax information, zoning information, land size and plat number. Commercial information, such as listing information for property for sale could be provided with contact numbers and pertinent marketing information downloaded. This could facilitate contacting the appropriate agent by linking to their voice-mail box, email address, or web site in the information download and allowing invocation of a phone call to their voice mailbox, generating an email message to their inbox, or accessing their web site.

Other applications include identifying the location that personnel are to go to for picking up an item, delivering an item, meeting other personnel, et cetera. Other applications include purchase an item from vending machines or controlling devices remotely based on the location of the user.

The system can be augmented to retain a list of the most recent uses or requests by the user, so that even if the user is not located in the same location as a previous request, the user can substitute the previous location coordinates for making a request. Alternatively, the user may be able to view a map and select a location to be used for providing information downloads even if that location was not previously used in an information download request. The selection of a remote location could be done by defining the GPS coordinates, viewing a map and identifying a location by using a mouse to locate a cursor over the desire location, or by selecting from a menu a city location. A typical application is for a user to select a location, such as a city from a menu or selected from a map and provide the user a weather map for the city the user is traveling to.

Call Center Integration

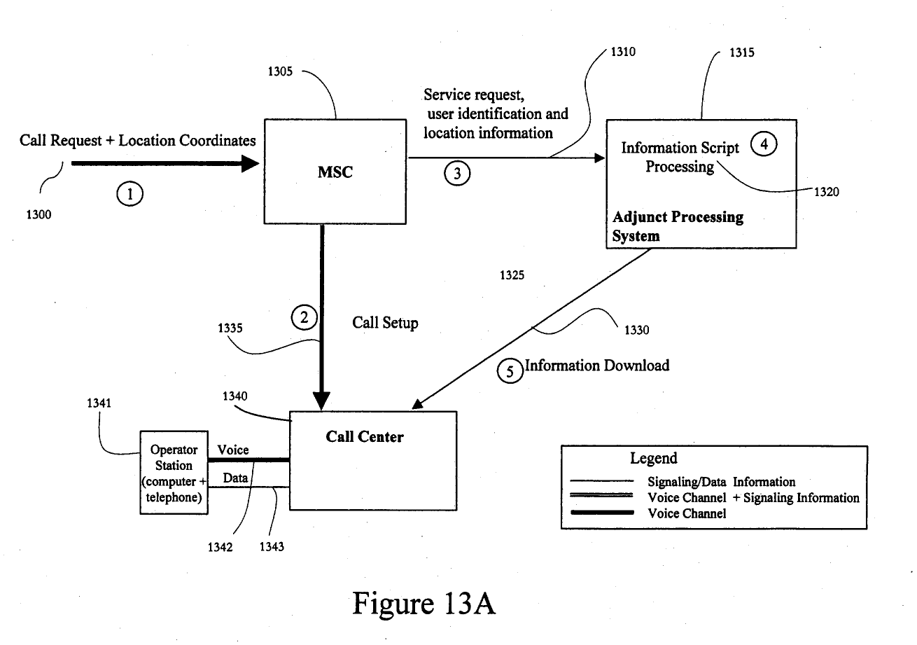

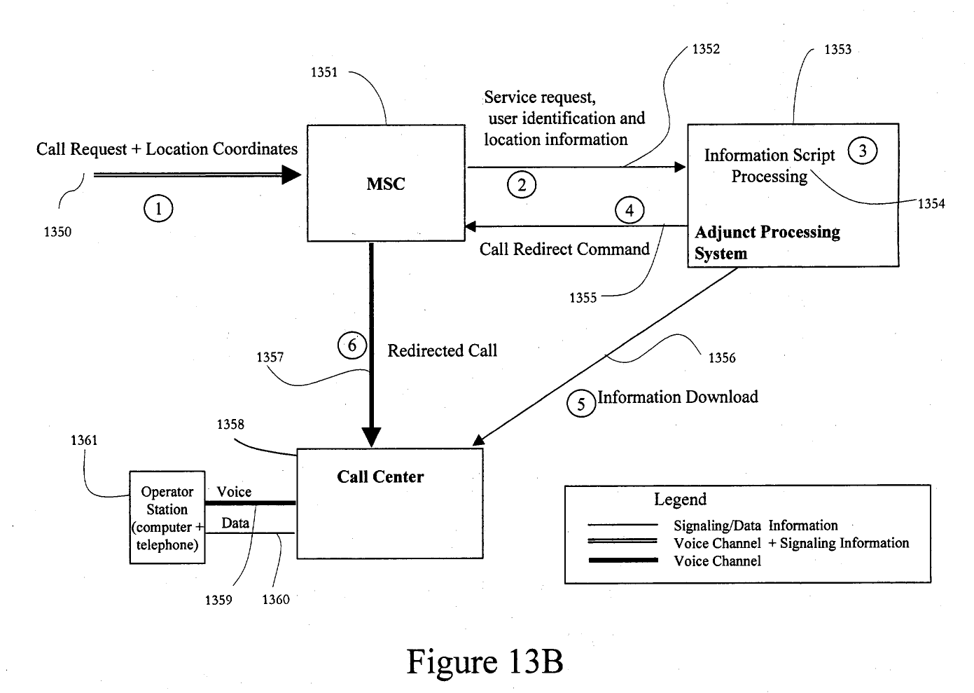

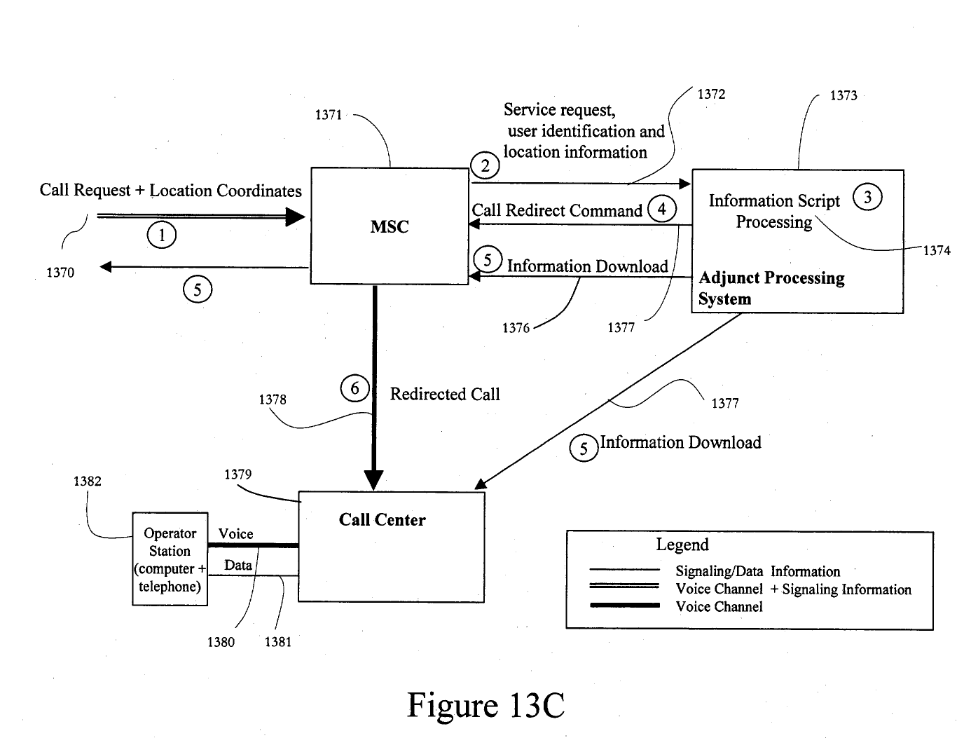

Other embodiments of the principles of the current invention are illustrated in FIG. 13A that combines the operation of a call center. In this embodiment, the first step occurs when a call request along with location coordinates are signaled 1300 to the MSC 1305. This embodiment involves communicating the GPS coordinates and the function request along with a call setup. The call setup signaling message can be adapted to incorporate the GPS coordinate information along with the function indication as known by those skilled in the art of wireless protocols. Alternatively, separate messages can be used, but regardless of the method, a call request, information download request, and the location information is communicated to the network.

Once the MSC 1305 receives the information, step two involves routing the call to the destination as indicated by the called party telephone number 1335. In this example, the call is routed 1335 to a call center 1340. Although it is shown as step three, it could be simultaneously, the MSC 1305 sends a service request, user identification, and user location information 1310 to the Adjunct Processing System 1315. The adjunct 1315 executes the information script as the fourth step 1320. As a result of the processing, the Adjunct sends information to a third party, which is identified as the call center 1340. Thus, step five is the download of information 1330 to the call center 1340.

Consequently, the call center receives both a call 1335 from the mobile user and information download associated with that call 1330 from the adjunct 1315. The call center comprises a voice switch (commonly known as a PBX) and a computer that are designed to interact in an integrated manner. The call center is able to coordinate the two instances of communication as is well known in the art of computer-telephony integration, and directs the information to an operator station 1341 that comprises a computer and telephone operated by a single person. This requires the call center to redirect the call to the operator station 1341 using a voice facility 1342 and the information from the adjunct over a data facility 1343. In this manner, the mobile user can originate a call request and information download request, and the call is directed to an agent or operator at a call center, and the information download is presented not to the mobile user, but to the call center.

This allows the operator at the call center to be presented a map of where the user is located while talking to the user. One application of this embodiment is for handling emergency calls (e.g., 911 calls) from a mobile subscriber. This allows the operator handling the call to have accurate information regarding the location of the caller. Alternatively, for non-emergency type calls, this embodiment facilitates providing directions or information to the user.

Two other variations are illustrated. In FIG. 13B, another embodiment is illustrated where the call completion is directed by the adjunct. Specifically, the user initiates a call with an information download request and their location coordinates 1350. This call, however, either does not specify a destination telephone number, or a ‘dummy’ value is indicated (i.e., one that does not complete). The MSC 1351, in the second step, sends a service request with the user identification and location information 1352 to the adjunct 1353. The adjunct executes the appropriate information script 1354 in step three. The adjunct then directed the MSC 1351 via a call redirection command in step four 1355 to redirect the call to a specified number (which is the call center in this embodiment). Immediately thereafter, the adjunct 1353 then communicates the appropriate information in step five 1356 to the call center. As the MSC 1351 redirects the call in step six 1357 to the call center, the call center 1358 receives both the call and information download. Once at the call center, the call is offered to an operator station 1361 comprising a voice terminal receiving the call over a voice channel 1359 and a data terminal receiving data over the data channel 1360.

This service embodiment allows the adjunct to direct the call as required, and the user is not required to indicate the appropriate number. This arrangement may require use of additional MSC capabilities, such as those defined for Wireless Intelligent network capabilities, or other mobile to MSC signaling capabilities, but those skilled in the art can readily define the necessary modifications based on the particular technology implementing this invention.

Finally, FIG. 13C illustrates yet another embodiment in which both the user and an operator at a call center are presented with the same information. This is particularly useful for real time collaboration between a mobile user in the field (e.g., technician) and a fixed location technician at a call center. The process begins in step one with the mobile user indicating a call request along with the information request and location coordinates 1370. The MSC 1371 receives the request and sends the appropriate information to the adjunct in step two 1372. The Adjunct Processing System 1373 executes the information script in step three 1374 and directs the MSC to transfer the call in step four 1377 followed by the information to be provided to the user in step five 1376. The adjunct also provides the same information to the call center 1379 in the information download of step five 1377. The call center 1379 receives the redirected call in step six 1378 and presents the voice and data information to an operator station 1382 comprising voice and data terminals receiving the information over voice 1380 and data 1381 connections from the call center.

In the embodiments illustrated in FIG. 13A-C, as well as all others illustrated, the steps can be altered, and the signaling messages used to convey the information can be of various type of standards representing various protocols. Those skilled in the art will recognize that many variations are possible based on the various technologies, standards, and protocols that can be used. For example, a user can be provided with an information download that includes a telephone number. After selecting the number and originating a call, the mobile user is in communication with an operator at a call center. The adjunct could also send related information to the call center that is displayed at the operator's terminal. In this manner, the user can communicate with an operator while the operator is viewing pertinent information.

I claim:

1. A method of providing information to a mobile device comprising:
receiving from the mobile device a service request and geographical positioning information associated with the mobile device;
processing the geographical positioning information and the service request to obtain a first information from an information service provider;
processing the first information in conjunction with the geographical location to obtain a second information to be downloaded to the user; and
downloading the second information to the user.

2. The method of claim 1 wherein the geographical position information is based on global position system (GPS) coordinates.

3. The method of claim 1 wherein the first information obtained from an information service provider comprises a geographical map.

4. The method of claim 1 wherein the step of receiving from the mobile device a service request and geographical position information associated with the mobile device further comprises receiving from the mobile device a service request, user identification information, and geographical position information associated with the mobile device.

5. The method of claim 1 wherein the second information obtained comprises a geographical map with the geographical location of the mobile device indicated.

6. The method of claim 1 wherein the step of downloading the second information to the user comprises processing the second information to orient the information based on the location of the user and downloading the information to the user.

7. A system for providing information to a mobile device from a wireless service provider upon request of the mobile device, comprising:
a mobile device capable of communicating a service request including information associated with the geographical location of the mobile device;
a mobile switch for receiving the service request from the mobile device and communicating with an adjunct processor; and
an adjunct processor retrieving information and processing information to be downloaded to the mobile device based in part on the geographical location information of the mobile device.

8. The system of claim 7 wherein the information associated with the geographical location of the mobile device comprises information obtained using a global positioning system receiver.

9. The system of claim 7 wherein the information downloaded comprises a geographical map.

10. The system of claim 7 where the mobile device comprises a display for display downloaded information.

11. The system of claim 7 wherein the adjunct processor comprises a database contain a geographical information system.

12. The system of claim 7 wherein the service request generated by the mobile device further comprises the telephone number of the mobile device.

13. The system of claim 7 wherein the adjunct processor accesses a database storing
credit information associated with the telephone number of the mobile device.

14. An apparatus for providing information to a mobile device upon request from the mobile device, comprising:
a memory adapted to store user service information including information pertaining to a service request for information; and
a processor, operatively connected to the memory for receiving service requests including geographical location information and obtaining information to be downloaded to the mobile device wherein the processor processes the obtained information based in part on the geographical location information of the mobile device.

15. The apparatus of claim 14 wherein the memory adapted to store user service information further comprises global positioning system coordinates.

16. The apparatus of claim 14 wherein the processor is further operatively connected to an information service provider via the Internet.

17. The apparatus of claim 14 wherein the processor further processes the obtain information based in part on the telephone number associated with the service request.

18. The apparatus of claim 14 wherein the memory is further adapted to store a service profile.

19. The apparatus of claim 14 further comprising a credit card verification system operatively connected to the processor.

20. The apparatus of claim 14 wherein the information downloaded comprises a geographical associated with the location coordinates of the mobile device.
